(19) United States
(12) Patent Application Publication
(10) Pub. No.: US 2015/0015701 A1
(43) Pub. Date: Jan. 15, 2015

(54) TRIANGULATION SCANNER HAVING MOTORIZED ELEMENTS

(71) Applicant: FARO Technologies, Inc., Lake Mary, FL (US)

(72) Inventor: Hao Yu, Wilmington, DE (US)

(21) Appl. No.: 14/325,814

(22) Filed: Jul. 8, 2014

Related U.S. Application Data
(60) Provisional application No. 61/844,627, filed on Jul. 10, 2013.

(51) Int. Cl. G01B 11/00; G01B 11/14; H04N 5/225

(52) U.S. Cl. CPC G01B 11/002; H04N 5/2259; G01B 11/14
USPC 348/136

(57) ABSTRACT

A 3D triangulation scanner includes a projector, a camera, and a processor. At least one of the projector and the camera has a zoom lens and a motorized zoom adjustment mechanism. The processor is responsive to executable instructions that uses triangulation calculations to calculate 3D coordinates of points on a surface that are based at least in part on a baseline length, an orientation of the projector and the camera, a position of a corresponding source point on an illuminated pattern source of the projector, and a position of a corresponding image point on a photosensitive array of the camera. The 3D coordinates of the points are calculated at one time and at another time, at least one of the projector FOV being wider at the one time than at the another time or the camera FOV being wider at the one time than at the another time.

### CROSS REFERENCE TO RELATED APPLICATIONS

This application claims the benefit of U.S. Provisional Application Ser. No. 61/844,627, filed Jul. 10, 2013, which is incorporated herein by reference in its entirety.

### BACKGROUND

The present disclosure relates to a triangulation scanner that measures three-dimensional (3D) coordinates.

A triangulation scanner measures 3D coordinates of a surface of an object by projecting a pattern of light onto the surface, imaging the light pattern with a camera, and performing a triangulation calculation to determine the 3D coordinates of points on the surface. A triangulation scanner includes a projector and a camera. The projector includes a source that provides an illuminated pattern and a projector lens, and the camera includes a lens and a photosensitive array.

Previously, triangulation scanners have included lenses with fixed focal lengths. To change the focal length of the projector lens or the camera lens, an operator would manually remove the lens and replace it with a lens having a different focal length. In most cases, this step is followed with a field compensation procedure to improve the accuracy of scanner measurements.

In an automated system, it may not be possible or efficient to suspend measurement to change lenses manually. On the other hand, it is often desirable to change lens focal lengths, for example, to improve accuracy by selecting a narrower field of view (FOV) or to increase measurement speed by selecting a wider FOV.

Besides providing a way to automatically change lens FOV, it would be desirable to provide a way to automatically change (1) the distance between projector and camera lenses and (2) the angles of the projector and camera systems in relation to the baseline connecting the projector and camera lenses. If such changes were possible, it would enable a single triangulation scanner to measure large objects quickly or measure smaller portions of an object with higher resolution and accuracy.

The art of scanning and measuring would be improved by providing a triangulation scanner having enhanced capabilities, especially for use in an automated system.

### BRIEF DESCRIPTION OF THE INVENTION

An embodiment of the invention is a noncontact optical three-dimensional (3D) scanning and measuring device having a projector, a camera, and a processor. The projector has an illuminated pattern source, a projector field of view (FOV), a projector perspective center, a projector near plane, and projector far plane, wherein a 3D region of space when disposed within the projector FOV and between the projector near plane and the projector far plane defines a projection-in-focus region. The camera has a photosensitive array, a camera FOV, a camera perspective center, a camera near plane, and a camera far plane, wherein a 3D region of space when disposed within the camera FOV and between the camera near plane and the camera far plane defines a camera-in-focus region. The processor is disposed in signal communication with the projector and the camera. The camera perspective center and the projector perspective center are disposed in relation to each other by a baseline having a baseline length. At least one of the projector and the camera has a zoom lens and a motorized zoom adjustment mechanism. The projector and the camera have a sweet-spot region that includes an overlap of the camera-in-focus region and the projector-in-focus region. 3D coordinates of points on a surface to be measured are measured when located within the sweet-spot region. The processor is responsive to executable instructions which when executed by the processor uses triangulation calculations to calculate the 3D coordinates of the points on the surface that are based at least in part on the baseline length, an orientation of the projector and the camera relative to the baseline, a position of a corresponding source point on the illuminated pattern source, and a position of a corresponding image point on the photosensitive array. The 3D coordinates of the points on the surface are calculated at one time and at another time, at least one of the projector FOV being wider at the one time than at the another time or the camera FOV being wider at the one time than at the another time.

Another embodiment of the invention is a measurement method using a noncontact optical three-dimensional (3D) scanning and measuring device. The noncontact 3D scanning and measuring device is provided having at least one of a motorized projector zoom lens and a motorized camera zoom lens and being mounted on a motorized moveable stage, the device having a projector and a camera. The device is moved to a desired position and the projector and the camera are set to a desired zoom, focus, tilt, and separation setting. A first pattern of light is projected via the projector onto a surface to be measured. An image of the first pattern of light on the surface is captured via the camera and a digital representation of the image is sent to a processor. First triangulation calculations to establish a first set of 3D coordinates of the surface are performed via the processor. At least one of the zoom and the focus for at least one of the projector and the camera is changed. A calibration artifact is illuminated via the projector and viewed via the camera. Compensation parameters for the device are determined via the processor using an optimization procedure, and a compensation procedure to improve measurement accuracy of the device is performed. Subsequent to the compensation procedure, a second pattern of light is projected via the projector onto the surface to be measured. A second image of the second pattern of light on the surface is captured via the camera, and a digital representation of the second image is sent to the processor. Second triangulation calculations to establish a second set of 3D coordinates of the surface are performed via the processor.

### BRIEF DESCRIPTION OF THE DRAWINGS

Referring to the exemplary non-limiting drawings wherein like elements are numbered alike in the accompanying Figures:

FIGS. 1 and 1C depict block diagrams of elements in a laser tracker having six-DOF capability;

FIGS. 1A and 1B depict schematic representations illustrating the principles of operation of triangulation based scanning measurement systems;

FIG. 2 depicts a flowchart of steps in a method of measuring three or more surface sets on an object surface with a coordinate measurement device and a target scanner;

FIGS. 3A and 3B depict schematic representations illustrating the principles of operation of triangulation based scanning measurement systems;

FIG. 4 depicts a top schematic view of a scanner;

FIG. 5 depicts a flow chart showing a method of operating the scanner of FIG. 4;

FIG. 6 depicts a top schematic view of a scanner;

FIG. 7 depicts a flow chart showing a method of operating the scanner of FIG. 6;

FIG. 8 depicts a triangulation scanner in accordance with an embodiment of the invention;

FIG. 9 depicts a triangulation scanner having motorized mechanism elements in accordance with an embodiment of the invention;

FIG. 10 depicts a motorized movable triangulation scanner in accordance with an embodiment of the invention;

FIG. 10A depicts calibration artifacts for use with a triangulation scanner in accordance with an embodiment of the invention; and

FIG. 11 depicts a flow chart showing a diagnostic method in accordance with an embodiment of the invention.

### DETAILED DESCRIPTION

A triangulation scanner may project a pattern of light in an area (2D) pattern onto an object surface. Such scanners are often referred to as structured light scanners. A discussion of structured light scanners is given in U.S. Published Application 2012/0262550 (publication '550) to Bridges, the entire contents of which are incorporated by reference herein, with exemplary paragraphs provided herein below.

### Discussion of Example Structured Light Scanners

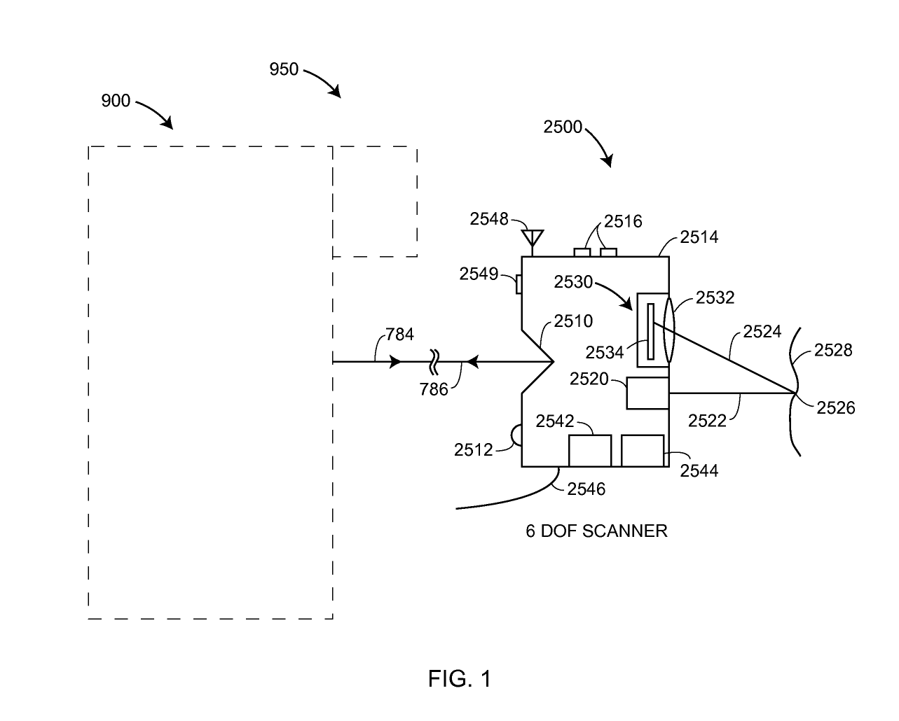

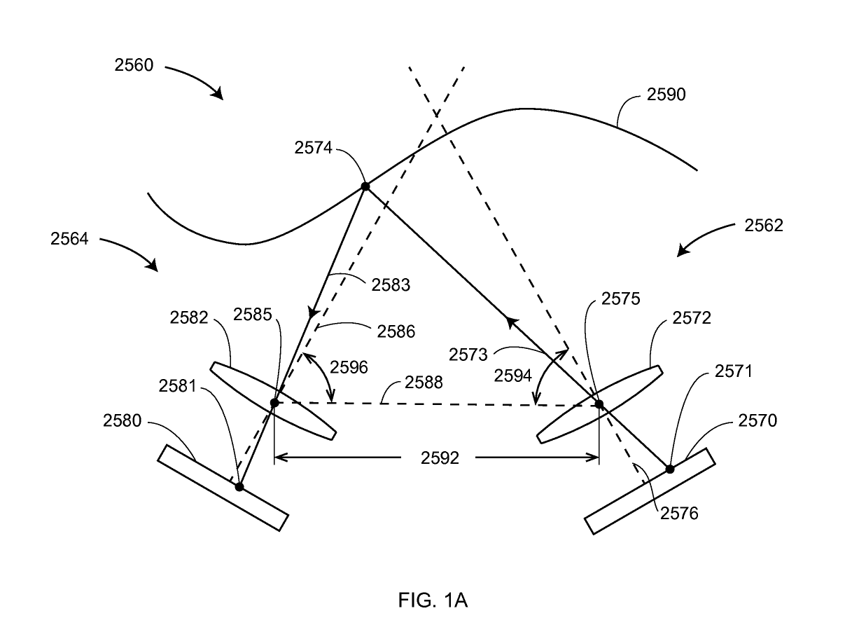

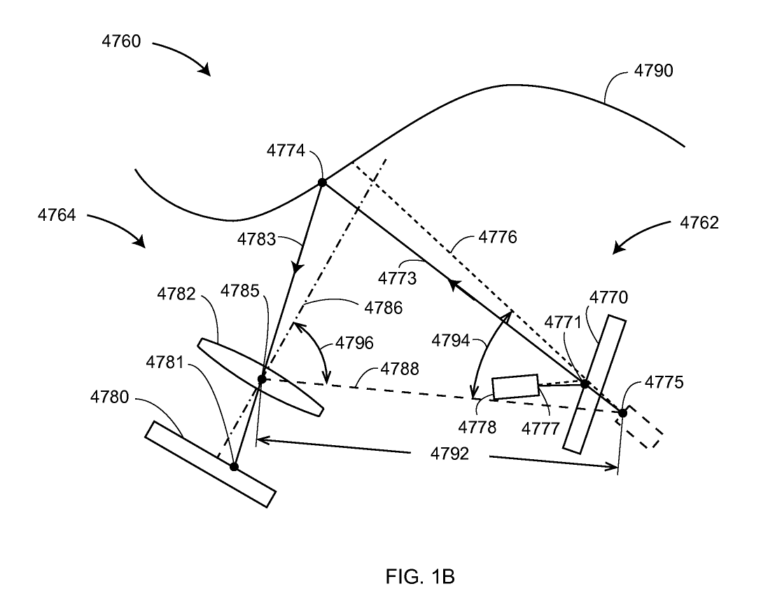

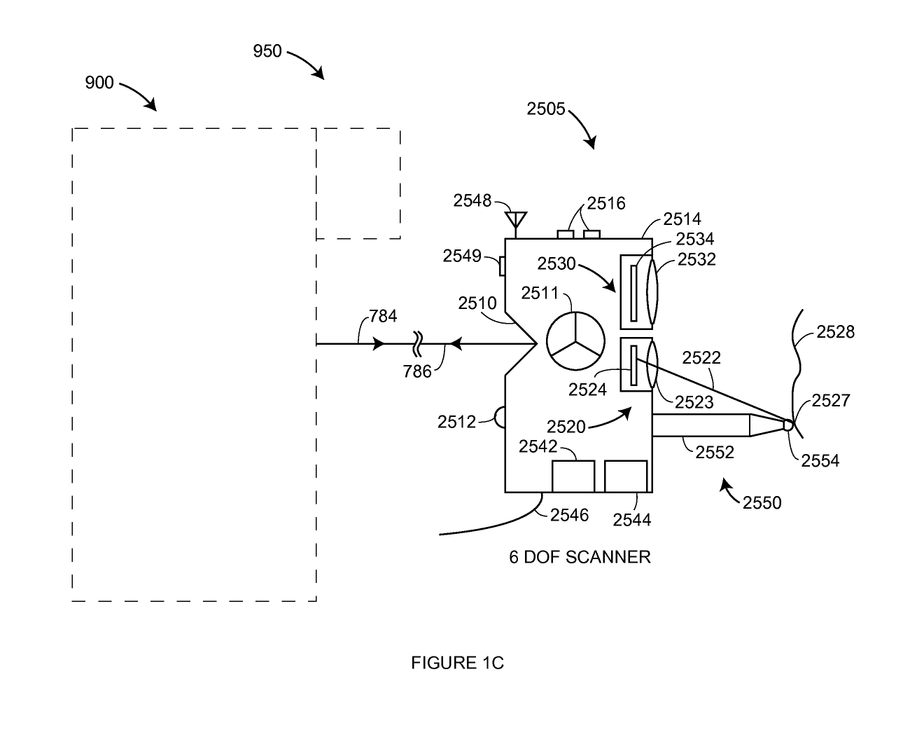

FIG. 1 shows an embodiment of a six-DOF scanner 2500 used in conjunction with an optoelectronic system 900 and a locator camera system 950. The six-DOF scanner 2500 may also be referred to as a “target scanner.” In another embodiment, the optoelectronic system 900 is replaced by the optoelectronic system that uses two or more wavelengths of light. The six-DOF scanner 2500 includes a body 2514, one or more retroreflectors 2510, 2511 a scanner camera 2530, a scanner light projector 2520, an optional electrical cable 2546, an optional battery 2444, an interface component 2512, an identifier element 2549, actuator buttons 2516, an antenna 2548, and an electronics circuit board 2542. Together, the scanner projector 2520 and the scanner camera 2530 are used to measure the three dimensional coordinates of a workpiece 2528. The camera 2530 includes a camera lens system 2532 and a photosensitive array 2534. The photosensitive array 2534 may be a CCD or CMOS array, for example. The scanner projector 2520 includes a projector lens system 2523 and a source pattern of light 2524. The source pattern of light may emit a point of light, a line of light, or a structured (two dimensional) pattern of light. If the scanner light source emits a point of light, the point may be scanned, for example, with a moving mirror, to produce a line or an array of lines. If the scanner light source emits a line of light, the line may be scanned, for example, with a moving mirror, to produce an array of lines. In an embodiment, the source pattern of light might be an LED, laser, or other light source reflected off a digital micromirror device (DMD) such as a digital light projector (DLP) from Texas Instruments, an liquid crystal device (LCD) or liquid crystal on silicon (LCOS) device, or it may be a similar device used in transmission mode rather than reflection mode. The source pattern of light might also be a slide pattern, for example, a chrome-on-glass slide, which might have a single pattern or multiple patterns, the slides moved in and out of position as needed. Additional retroreflectors, such as retroreflector 2511, may be added to the first retroreflector 2510 to enable the laser tracker to track the six-DOF scanner from a variety of directions, thereby giving greater flexibility in the directions to which light may be projected by the six-DOF projector 2500.

The 6-DOF scanner 2500 may be held by hand or mounted, for example, on a tripod, an instrument stand, a motorized carriage, or a robot end effector. The three dimensional coordinates of the workpiece 2528 is measured by the scanner camera 2530 by using the principles of triangulation. There are several ways that the triangulation measurement may be implemented, depending on the pattern of light emitted by the scanner light source 2520 and the type of photosensitive array 2534. For example, if the pattern of light emitted by the scanner light source 2520 is a line of light or a point of light scanned into the shape of a line and if the photosensitive array 2534 is a two dimensional array, then one dimension of the two dimensional array 2534 corresponds to a direction of a point 2526 on the surface of the workpiece 2528. The other dimension of the two dimensional array 2534 corresponds to the distance of the point 2526 from the scanner light source 2520. Hence the three dimensional coordinates of each point 2526 along the line of light emitted by scanner light source 2520 is known relative to the local frame of reference of the 6-DOF scanner 2500. The six degrees of freedom of the 6-DOF scanner are known by the six-DOF laser tracker using known methods. From the six degrees of freedom, the three dimensional coordinates of the scanned line of light may be found in the tracker frame of reference, which in turn may be converted into the frame of reference of the workpiece 2528 through the measurement by the laser tracker of three points on the workpiece, for example.

If the 6-DOF scanner 2500 is held by hand, a line of laser light emitted by the scanner light source 2520 may be moved in such a way as to “paint” the surface of the workpiece 2528, thereby obtaining the three dimensional coordinates for the entire surface. It is also possible to “paint” the surface of a workpiece using a scanner light source 2520 that emits a structured pattern of light. Alternatively, when using a scanner 2500 that emits a structured pattern of light, more accurate measurements may be made by mounting the 6-DOF scanner on a tripod or instrument stand. The structured light pattern emitted by the scanner light source 2520 might, for example, include a pattern of fringes, each fringe having an irradiance that varies sinusoidally over the surface of the workpiece 2528. In an embodiment, the sinusoids are shifted by three or more phase values. The amplitude level recorded by each pixel of the camera 2530 for each of the three or more phase values is used to provide the position of each pixel on the sinusoid. This information is used to help determine the three dimensional coordinates of each point 2526. In another embodiment, the structured light may be in the form of a coded pattern that may be evaluated to determine three-dimensional coordinates based on single, rather than multiple, image frames collected by the camera 2530. Use of a coded pattern may enable relatively accurate measurements while the 6-DOF scanner 2500 is moved by hand at a reasonable speed.

Projecting a structured light pattern, as opposed to a line of light, has some advantages. In a line of light projected from a handheld six-DOF scanner 2500, the density of points may be high along the line but much less between the lines. With a structured light pattern, the spacing of points is usually about the same in each of the two orthogonal directions. In addition, in some modes of operation, the three-dimensional points calculated with a structured light pattern may be more accurate than other methods. For example, by fixing the six-DOF scanner 2500 in place, for example, by attaching it to a stationary stand or mount, a sequence of structured light patterns may be emitted that enable a more accurate calculation than would be possible other methods in which a single pattern was captured (i.e., a single-shot method). An example of a sequence of structured light patterns is one in which a pattern having a first spatial frequency is projected onto the object. In an embodiment, the projected pattern is pattern of stripes that vary sinusoidally in optical power. In an embodiment, the phase of the sinusoidally varying pattern is shifted, thereby causing the stripes to shift to the side. For example, the pattern may be made to be projected with three phase angles, each shifted by 120 degrees relative to the previous pattern. This sequence of projections provides enough information to enable relatively accurate determination of the phase of each point of the pattern, independent of the background light. This can be done on a point by point basis without considering adjacent points on the object surface.

Although the procedure above determines a phase for each point with phases running from 0 to 360 degrees between two adjacent lines, there may still be a question about which line is which. A way to identify the lines is to repeat the sequence of phases, as described above, but using a sinusoidal pattern with a different spatial frequency (i.e., a different fringe pitch). In some cases, the same approach needs to be repeated for three or four different fringe pitches. The method of removing ambiguity using this method is well known in the art and is not discussed further here.

To obtain the best possible accuracy using a sequential projection method such as a sinusoidal phase-shift method, it may be advantageous to minimize the movement of the six-DOF scanner. Although the position and orientation of the six-DOF scanner are known from the six-DOF measurements made by the laser tracker and although corrections can be made for movements of a handheld six-DOF scanner, the resulting noise will be somewhat higher than it would have been if the scanner were kept stationary by placing it on a stationary mount, stand, or fixture.

The scanning methods represented by FIG. 1 are based on the principle of triangulation. A more complete explanation of the principles of triangulation are given with reference to the system 2560 of FIG. 1A and the system 4760 of FIG. 1B. Referring first to FIG. 1A, the system 2560 includes a projector 2562 and a camera 2564. The projector 2562 includes a source pattern of light 2570 lying on a source plane and a projector lens 2572. The projector lens may include several lens elements. The projector lens has a lens perspective center 2575 and a projector optical axis 2576. The ray of light 2573 travels from a point 2571 on the source pattern of light through the lens perspective center onto the object 2590, which it intercepts at a point 2574.

The camera 2564 includes a camera lens 2582 and a photosensitive array 2580. The camera lens 2582 has a lens perspective center 2585 and an optical axis 2586. A ray of light 2583 travels from the object point 2574 through the camera perspective center 2585 and intercepts the photosensitive array 2580 at point 2581.

The line segment that connects the perspective centers is the baseline 2588 in FIG. 1A and the baseline 4788 in FIG. 1B. The length of the baseline is called the baseline length (2592, 4792). The angle between the projector optical axis and the baseline is the baseline projector angle (2594, 4794). The angle between the camera optical axis (2583, 4786) and the baseline is the baseline camera angle (2596, 4796). If a point on the source pattern of light (2570, 4771) is known to correspond to a point on the photosensitive array (2581, 4781), then it is possible using the baseline length, baseline projector angle, and baseline camera angle to determine the sides of the triangle connecting the points 2585, 2574, and 2575, and hence determine the surface coordinates of points on the surface of object 2590 relative to the frame of reference of the measurement system 2560. To do this, the angles of the sides of the small triangle between the projector lens 2572 and the source pattern of light 2570 are found using the known distance between the lens 2572 and plane 2570 and the distance between the point 2571 and the intersection of the optical axis 2576 with the plane 2570. These small angles are added or subtracted from the larger angles 2596 and 2594 as appropriate to obtain the desired angles of the triangle. It will be clear to one of ordinary skill in the art that equivalent mathematical methods can be used to find the lengths of the sides of the triangle 2574-2585-2575 or that other related triangles may be used to obtain the desired coordinates of the surface of object 2590.

Referring first to FIG. 1B, the system 4760 is similar to the system 2560 of FIG. 1A except that the system 4760 does not include a lens. The system may include a projector 4762 and a camera 4764. In the embodiment illustrated in FIG. 1B, the projector includes a light source 4778 and a light modulator 4770. The light source 4778 may be a laser light source since such a light source may remain in focus for a long distance using the geometry of FIG. 1B. A ray of light 4773 from the light source 4778 strikes the optical modulator 4770 at a point 4771. Other rays of light from the light source 4778 strike the optical modulator at other positions on the modulator surface. In an embodiment, the optical modulator 4770 changes the power of the emitted light, in most cases by decreasing the optical power to a degree. In this way, the optical modulator imparts an optical pattern to the light, referred to here as the source pattern of light, which is at the surface of the optical modulator 4770. The optical modulator 4770 may be a DLP or LCOS device for example. In some embodiments, the modulator 4770 is transmissive rather than reflective. The light emerging from the optical modulator 4770 appears to emerge from a virtual light perspective center 4775. The ray of light appears to emerge from the virtual light perspective center 4775, pass through the point 4771, and travel to the point 4774 at the surface of object 4790.

The baseline is the line segment extending from the camera lens perspective center 4785 to the virtual light perspective center 4775. In general, the method of triangulation involves finding the lengths of the sides of a triangle, for example, the triangle having the vertex points 4774, 4785, and 4775. A way to do this is to find the length of the baseline, the angle between the baseline and the camera optical axis 4786, and the angle between the baseline and the projector reference axis 4776. To find the desired angle, additional smaller angles are found. For example, the small angle between the camera optical axis 4786 and the ray 4783 can be found by solving for the angle of the small triangle between the camera lens 4782 and the photosensitive array 4780 based on the distance from the lens to the photosensitive array and the distance of the pixel from the camera optical axis. The angle of the small triangle is then added to the angle between the baseline and the camera optical axis to find the desired angle. Similarly for the projector, the angle between the projector reference axis 4776 and the ray 4773 is found can be found by solving for the angle of the small triangle between these two lines based on the known distance of the light source 4777 and the surface of the optical modulation and the distance of the projector pixel at 4771 from the intersection of the reference axis 4776 with the surface of the optical modulator 4770. This angle is subtracted from the angle between the baseline and the projector reference axis to get the desired angle.

The camera 4764 includes a camera lens 4782 and a photosensitive array 4780. The camera lens 4782 has a camera lens perspective center 4785 and a camera optical axis 4786. The camera optical axis is an example of a camera reference axis. From a mathematical point of view, any axis that passes through the camera lens perspective center may equally easily be used in the triangulation calculations, but the camera optical axis, which is an axis of symmetry for the lens, is customarily selected. A ray of light 4783 travels from the object point 4774 through the camera perspective center 4785 and intercepts the photosensitive array 4780 at point 4781. Other equivalent mathematical methods may be used to solve for the lengths of the sides of a triangle 4774-4785-4775, as will be clear to one of ordinary skill in the art.

Although the triangulation method described here is well known, some additional technical information is given hereinbelow for completeness. Each lens system has an entrance pupil and an exit pupil. The entrance pupil is the point from which the light appears to emerge, when considered from the point of view of first-order optics. The exit pupil is the point from which light appears to emerge in traveling from the lens system to the photosensitive array. For a multi-element lens system, the entrance pupil and exit pupil do not necessarily coincide, and the angles of rays with respect to the entrance pupil and exit pupil are not necessarily the same. However, the model can be simplified by considering the perspective center to be the entrance pupil of the lens and then adjusting the distance from the lens to the source or image plane so that rays continue to travel along straight lines to intercept the source or image plane. In this way, the simple and widely used model shown in FIG. 1A is obtained. It should be understood that this description provides a good first order approximation of the behavior of the light but that additional fine corrections can be made to account for lens aberrations that can cause the rays to be slightly displaced relative to positions calculated using the model of FIG. 1A. Although the baseline length, the baseline projector angle, and the baseline camera angle are generally used, it should be understood that saying that these quantities are required does not exclude the possibility that other similar but slightly different formulations may be applied without loss of generality in the description given herein.

When using a six-DOF scanner, several types of scan patterns may be used, and it may be advantageous to combine different types to obtain the best performance in the least time. For example, in an embodiment, a fast measurement method uses a two-dimensional coded pattern in which three-dimensional coordinate data may be obtained in a single shot. In a method using coded patterns, different characters, different shapes, different thicknesses or sizes, or different colors, for example, may be used to provide distinctive elements, also known as coded elements or coded features. Such features may be used to enable the matching of the point 2571 to the point 2581. A coded feature on the source pattern of light 2570 may be identified on the photosensitive array 2580.

A technique that may be used to simplify the matching of coded features is the use of epipolar lines. Epipolar lines are mathematical lines formed by the intersection of epipolar planes and the source plane 2570 or the image plane 2580. An epipolar plane is any plane that passes through the projector perspective center and the camera perspective center. The epipolar lines on the source plane and image plane may be parallel in some special cases, but in general are not parallel. An aspect of epipolar lines is that a given epipolar line on the projector plane has a corresponding epipolar line on the image plane. Hence, any particular pattern known on an epipolar line in the projector plane may be immediately observed and evaluated in the image plane. For example, if a coded pattern is placed along an epipolar line in the projector plane that the spacing between coded elements in the image plane may be determined using the values read out by pixels of the photosensitive array 2580 and this information used to determine the three-dimensional coordinates of an object point 2574. It is also possible to tilt coded patterns at a known angle with respect to an epipolar line and efficiently extract object surface coordinates.

An advantage of using coded patterns is that three-dimensional coordinates for object surface points can be quickly obtained. However, in most cases, a sequential structured light approach, such as the sinusoidal phase-shift approach, will give more accurate results. Therefore, the user may advantageously choose to measure certain objects or certain object areas or features using different projection methods according to the accuracy desired. By using a programmable source pattern of light, such a selection may easily be made.

An important limitation in the accuracy of scanners may be present for certain types of objects. For example, some features such as holes or recesses may be difficult to scan effectively. The edges of objects or holes may be difficult to obtain as smoothly as might be desired. Some types of materials may not return as much light as desired or may have a large penetration depth for the light. In other cases, light may reflect off more than one surface (multipath interference) before returning to the scanner so that the observed light is “corrupted,” thereby leading to measurement errors. In any of these cases, it may be advantageous to measure the difficult regions using a six-DOF scanner 2505 shown in FIG. 1C that includes a tactile probe such as the probe tip 2554, which is part of the probe extension assembly 2550. After it has been determined that it would be advantageous to measure with a tactile probe, the projector 2520 may send a laser beam to illuminate the region to be measured. In FIG. 1C, a projected ray of beam of light 2522 is illuminating a point 2527 on an object 2528, indicating that this point is to be measured by the probe extension assembly 2550. In some cases, the tactile probe may be moved outside the field of projection of the projector 2550 so as to avoid reducing the measurement region of the scanner. In this case, the beam 2522 from the projector may illuminate a region that the operator may view. The operator can then move the tactile probe 2550 into position to measure the prescribed region. In other cases, the region to be measured may be outside the projection range of the scanner. In this case, the scanner may point the beam 2522 to the extent of its range in the direction to be measured or it may move the beam 2522 in a pattern indicating the direction to which the beam should be placed. Another possibility is to present a CAD model or collected data on a display monitor and then highlight on the display those regions of the CAD model or collected data that should be re-measured. It is also possible to measure highlighted regions using other tools, for example, a spherically mounted retroreflector or a six-DOF probe under control of a laser tracker.

The projector 2520 may project a two dimensional pattern of light, which is sometimes called structured light. Such light emerges from the projector lens perspective center and travels in an expanding pattern outward until it intersects the object 2528. Examples of this type of pattern are the coded pattern and the periodic pattern, both discussed hereinabove. The projector 2520 may alternatively project a one-dimensional pattern of light. Such projectors are sometimes referred to as laser line probes or laser line scanners. Although the line projected with this type of scanner has width and a shape (for example, it may have a Gaussian beam profile in cross section), the information it contains for the purpose of determining the shape of an object is one dimensional. So a line emitted by a laser line scanner intersects an object in a linear projection. The illuminated shape traced on the object is two dimensional. In contrast, a projector that projects a two-dimensional pattern of light creates an illuminated shape on the object that is three dimensional. One way to make the distinction between the laser line scanner and the structured light scanner is to define the structured light scanner as a type of scanner that contains at least three non-collinear pattern elements. For the case of a two-dimensional pattern that projects a coded pattern of light, the three non-collinear pattern elements are recognizable because of their codes, and since they are projected in two dimensions, the at least three pattern elements must be non-collinear. For the case of the periodic pattern, such as the sinusoidally repeating pattern, each sinusoidal period represents a plurality of pattern elements. Since there is a multiplicity of periodic patterns in two dimensions, the pattern elements must be non-collinear. In contrast, for the case of the laser line scanner that emits a line of light, all of the pattern elements lie on a straight line. Although the line has width and the tail of the line cross section may have less optical power than the peak of the signal, these aspects of the line are not evaluated separately in finding surface coordinates of an object and therefore do not represent separate pattern elements. Although the line may contain multiple pattern elements, these pattern elements are collinear.

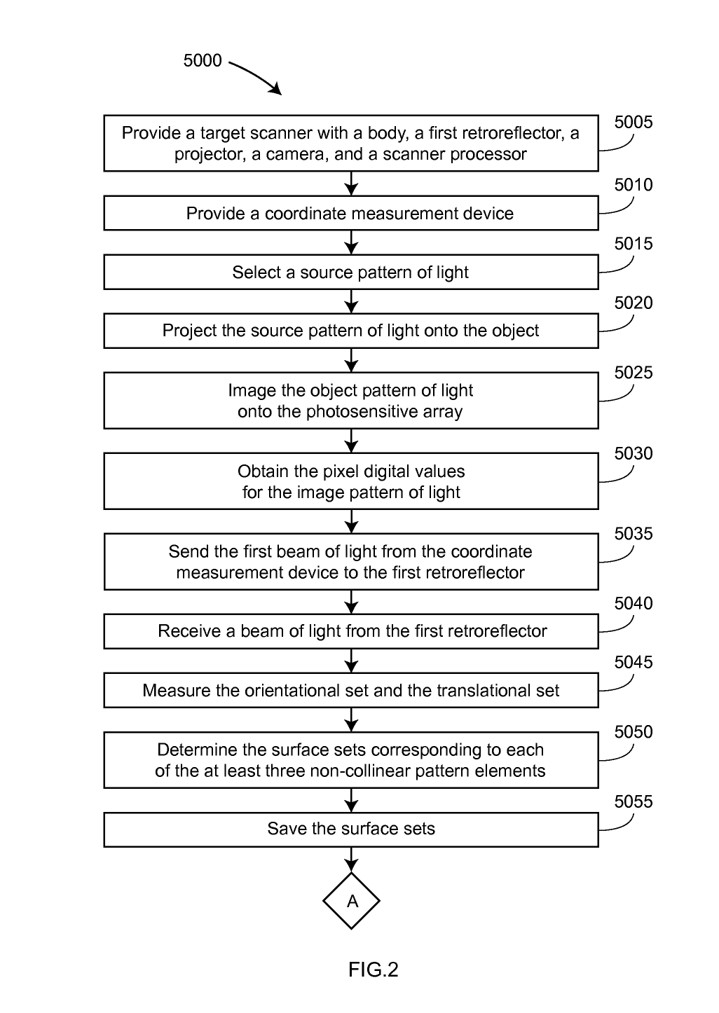

FIG. 2 is a flowchart illustrating steps 5000 in a method of measuring three or more surface sets on an object surface with a coordinate measurement device and a target scanner, each of the three or more surface sets being three-dimensional coordinates of a point on the object surface in a device frame of reference, each surface set including three values, the device frame of reference being associated with the coordinate measurement device.

The step 5005 is to provide the target scanner with a body, a first retroreflector, a projector, a camera, and a scanner processor, wherein the first retroreflector, projector, and camera are rigidly affixed to the body, and the target scanner is mechanically detached from the coordinate measurement device. In this step, the projector includes a source pattern of light, the source pattern of light located on a source plane and including at least three non-collinear pattern elements, the projector is configured to project the source pattern of light onto the object to form an object pattern of light on the object, and each of the at least three non-collinear pattern elements correspond to at least one surface set. Also in this step, the camera includes a camera lens and a photosensitive array, the camera lens configured to image the object pattern of light onto the photosensitive array as an image pattern of light, the photosensitive array including camera pixels, the photosensitive array configured to produce, for each camera pixel, a corresponding pixel digital value responsive to an amount of light received by the camera pixel from the image pattern of light.

The step 5010 is to provide the coordinate measurement device, the coordinate measurement device configured to measure a translational set and an orientational set, the translational set being values of three translational degrees of freedom of the target scanner in the device frame of reference and the orientational set being values of three orientational degrees of freedom of the target scanner in the device frame of reference, the translational set and the orientational set being sufficient to define a position and orientation of the target scanner in space, the coordinate measurement device configured to send a first beam of light to the first retroreflector and to receive a second beam of light from the first retroreflector, the second beam of light being a portion of the first beam of light, the coordinate measurement device including a device processor, the device processor configured to determine the orientational set and the translational set, the translational set based at least in part on the second beam of light. Also in this step, the scanner processor and the device processor are jointly configured to determine the three or more surface sets, each of the surface sets based at least in part on the translational set, the orientational set, and the pixel digital values.

The step 5015 is to select the source pattern of light.

The step 5020 is to project the source pattern of light onto the object to produce the object pattern of light.

The step 5025 is to image the object pattern of light onto the photosensitive array to obtain the image pattern of light.

The step 5030 is to obtain the pixel digital values for the image pattern of light.

The step 5035 is to send the first beam of light from the coordinate measurement device to the first retroreflector.

The step 5040 is to receive the second beam of light from the first retroreflector.

The step 5045 is to measure the orientational set and the translational set, the translational set based at least in part on the second beam of light.

The step 5050 is to determine the surface sets corresponding to each of the at least three non-collinear pattern elements.

The step 5055 is to save the surface sets. The method 5000 concludes with marker A.

Alternatively, a triangulation scanner may project a line of light, where it is understood that the line is seen as a line when viewed in a plane perpendicular to the direction of propagation of the light. It is also understood that projecting a line of light does not necessarily imply that the line is perfectly straight but that it generally projected in a linear pattern. A discussion of line scanners is given in U.S. Published Application 2012/0262573 (publication '573) to Bridges, the entire contents of which are incorporated by reference herein, with exemplary paragraphs provided herein below.

### Discussion of Example Line Scanners

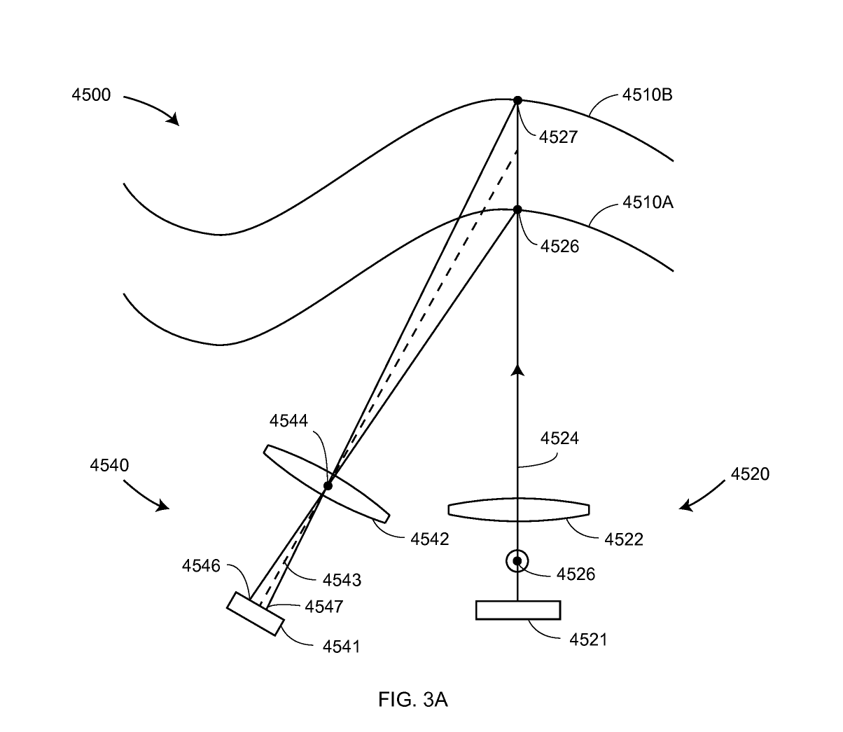

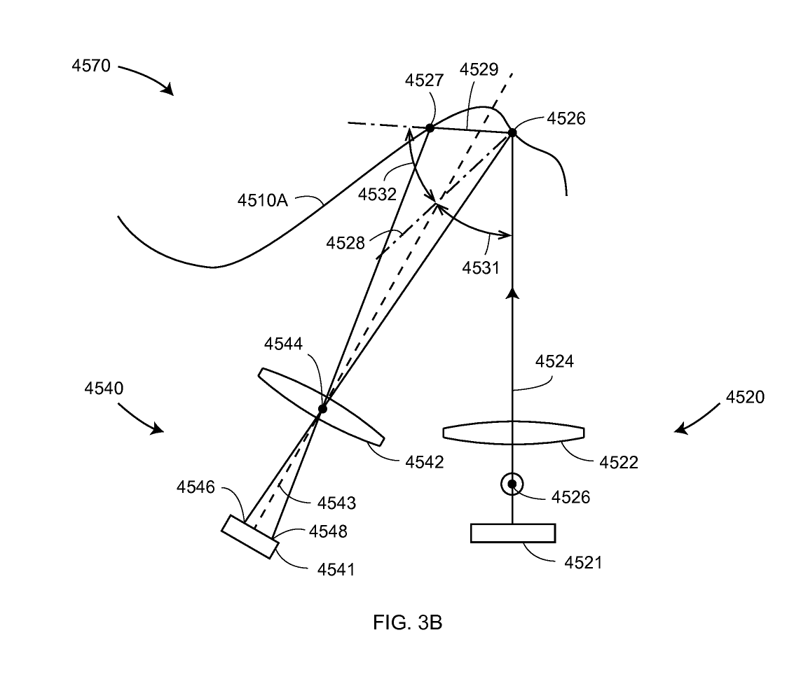

A method for calculating three dimensional coordinates of an object surface is now given with reference to FIG. 3A. The line scanner system 4500 includes a projector 4520 and a camera 4540. The projector 4520 includes a source pattern of light 4521 and a projector lens 4522. The source pattern of light includes an illuminated pattern in the form of a line. The projector lens includes a projector perspective center and a projector optical axis that passes through the projector perspective center. In the example of FIG. 3A, a central ray of the beam of light 4524 is aligned with the perspective optical axis. The camera 4540 includes a camera lens 4542 and a photosensitive array 4541. The lens has a camera optical axis 4543 that passes through a camera lens perspective center 4544. In the exemplary system 4500, the projector optical axis, which is aligned to the beam of light 4524, and the camera lens optical axis 4544, are perpendicular to the line of light 4526 projected by the source pattern of light 4521. In other words, the line 4526 is in the direction perpendicular to the paper in FIG. 3A. The line strikes an object surface, which at a first distance from the projector is object surface 4510A and at a second distance from the projector is object surface 4520A. It is understood that at different heights above or below the paper of FIG. 3A, the object surface may be at a different distance from the projector than the distance to either object surface 4520A or 4520B. For a point on the line of light 4526 that also lies in the paper of FIG. 15D, the line of light intersects surface 4520A in a point 4526 and it intersects the surface 4520B in a point 4527. For the case of the intersection point 4526, a ray of light travels from the point 4526 through the camera lens perspective center 4544 to intersect the photosensitive array 4541 in an image point 4546. For the case of the intersection point 4527, a ray of light travels from the point 4527 through the camera lens perspective center to intersect the photosensitive array 4541 in an image point 4547. By noting the position of the intersection point relative to the position of the camera lens optical axis 4544, the distance from the projector (and camera) to the object surface can be determined. The distance from the projector to other points on the line of light 4526, that is points on the line of light that do not lie in the plane of the paper of FIG. 3A, may similarly be found. In the usual case, the pattern on the photosensitive array will be a line of light (in general, not a straight line), where each point in the line corresponds to a different position perpendicular to the plane of the paper, and the position perpendicular to the plane of the paper contains the information about the distance from the projector to the camera. Therefore, by evaluating the pattern of the line in the image of the photosensitive array, the three-dimensional coordinates of the object surface along the projected line can be found. Note that the information contained in the image on the photosensitive array for the case of a line scanner is contained in a (not generally straight) line. In contrast, the information contained in the two-dimensional projection pattern of structured light contains information over both dimensions of the image in the photosensitive array.

It should be noted that although the descriptions given above distinguish between line scanners and area (structured light) scanners based on whether three or more pattern elements are collinear, it should be noted that the intent of this criterion is to distinguish patterns projected as areas and as lines. Consequently patterns projected in a linear fashion having information only along a single path are still line patterns even though the one-dimensional pattern may be curved.

An important advantage that a line scanner may have over a structured light scanner in some cases is in its greater ability to detect the multipath interference. In an ordinary (desired) case, each ray of light emerging from the projector and striking the object surface may be considered to generally reflect in a direction away from the object. For the usual case, the surface of the object is not highly reflective (i.e., a mirror like surface), so that almost all of the light is diffusely reflected (scattered) rather than being specularly reflected. The diffusely reflected light does not all travel in a single direction as would reflected light in the case of a mirror-like surface but rather scatters in a pattern. The general direction of the scattered light may be found in the same fashion as in the reflection of light off a mirror-like surface, however. This direction may be found by drawing a normal to the surface of the object at the point of intersection of the light from the projector with the object. The general direction of the scattered light is then found as the reflection of the incident light about the surface normal. In other words, the angle of reflection is equal to the angle of incidence, even though the angle of reflection is only a general scattering direction in this case.

The case of multipath interference occurs when the some of the light that strikes the object surface is first scattered off another surface of the object before returning to the camera. For the point on the object that receives this scattered light, the light sent to the photosensitive array then corresponds not only to the light directly projected from the projector but also to the light sent to a different point on the projector and scattered off the object. The result of multipath interference, especially for the case of scanners that project two-dimensional (structured) light, may be to cause the distance calculated from the projector to the object surface at that point to be inaccurate.

For the case of a line scanner, there is a way to determine if multipath interference is present. In an embodiment, the rows of a photosensitive array are parallel to the plane of the paper in FIG. 3B and the columns are perpendicular to the plane of the paper. Each row represents one point on the projected line 4526 in the direction perpendicular to the plane of the paper. In an embodiment, the distance from the projector to the object for that point on the line is found by first calculating the centroid for each row. However, the light on each row should be concentrated over a region of contiguous pixels. If there are two or more regions that receive a significant amount of light, multipath interference is indicated. An example of such a multipath interference condition and the resulting extra region of illumination on the photosensitive array are shown in FIG. 3B. The surface 4510A now has a greater curvature near the point of intersection 4526. The surface normal at the point of intersection is the line 4528, and the angle of incidence is 4531. The direction of the reflected line of light 4529 is found from the angle of reflection 4532, which is equal to the angle of incidence. As stated hereinabove, the line of light 4529 actually represents an overall direction for light that scatters over a range of angles. The center of the scattered light strikes the object 4510A at the point 4527, which is imaged by the lens 4544 at the point 4548 on the photosensitive array. The unexpectedly high amount of light received in the vicinity of point 4548 indicates that multipath interference is probably present. For a line scanner, the main concern with multipath interference is not for the case shown in FIG. 3B, where the two spots 4546 and 4541 are separated by a considerable distance and can be analyzed separately but rather for the case in which the two spots overlap or smear together. In this case, it is not possible to determine the centroid corresponding to the desired point, which in FIG. 3B corresponds to the point 4546. The problem is made worse for the case of a scanner that projects light in two dimensions as can be understood by again referring to FIG. 3B. If all of the light imaged onto the photosensitive array 4541 were needed to determine two-dimensional coordinates, then it is clear that the light at the point 4527 would correspond to the desired pattern of light directly projected from the projector as well as the unwanted light reflected to the point 4527 from a reflection off the object surface. As a result, in this case, the wrong three dimensional coordinates would likely be calculated for the point 4527 for two dimensional projected light.

It is possible to project a single spot with a projector on a triangulation scanner. With modern programmable devices such as digital micromirror devices (DMDs) or liquid crystal on silicon (LCOS) displays, it is possible to sweep a point to form a line or to sweep a point in a raster pattern to cover an area. Similarly it is possible to sweep a line to cover an area.

Advantages of providing different FOVs are discussed in U.S. Patent Application No. 61/791,797 (application '797) to Tohme, et al., the entire contents of which are incorporated by reference herein, with exemplary paragraphs provided herein below.

Discussion of Different FOVs in Triangulation Scanners

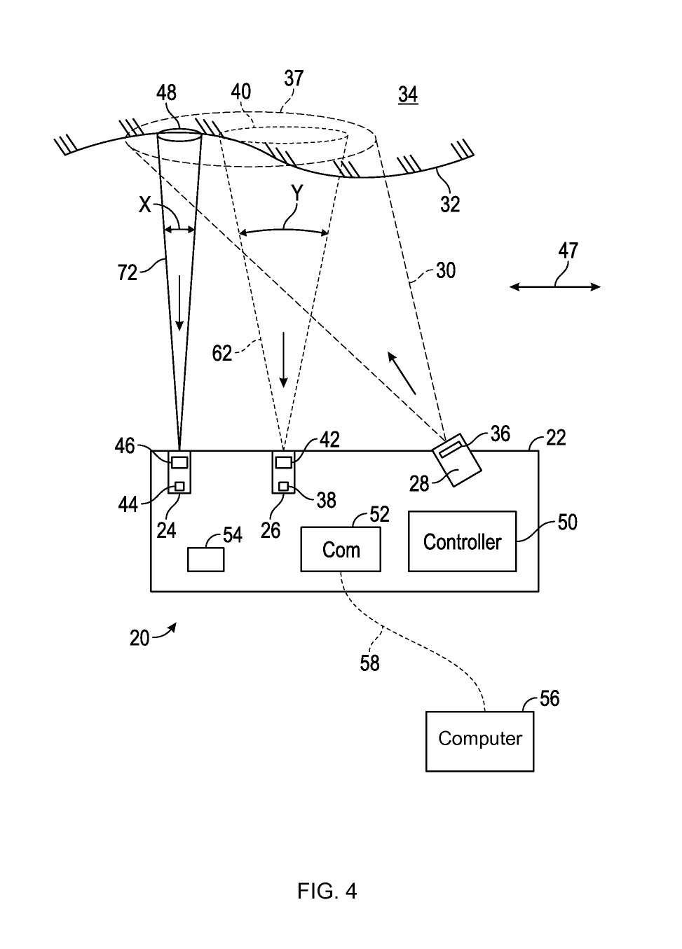

Scanner devices acquire three-dimensional coordinate data of objects. In one embodiment, a scanner 20 shown in FIG. 4 has a housing 22 that includes a first camera 24, a second camera 26 and a projector 28. The projector 28 emits light 30 onto a surface 32 of an object 34. In the exemplary embodiment, the projector 28 uses a visible light source that illuminates a pattern generator. The visible light source may be a laser, a superluminescent diode, an incandescent light, a Xenon lamp, a light emitting diode (LED), or other light emitting device for example. In one embodiment, the pattern generator is a chrome-on-glass slide having a structured light pattern etched thereon. The slide may have a single pattern or multiple patterns that move in and out of position as needed. The slide may be manually or automatically installed in the operating position. In other embodiments, the source pattern may be light reflected off or transmitted by a digital micro-mirror device (DMD) such as a digital light projector (DLP) manufactured by Texas Instruments Corporation, a liquid crystal device (LCD), a liquid crystal on silicon (LCOS) device, or a similar device used in transmission mode rather than reflection mode. The projector 28 may further include a lens system 36 that alters the outgoing light to cover the desired area.

In this embodiment, the projector 28 is configurable to emit a structured light over an area 37. As used herein, the term “structured light” refers to a two-dimensional pattern of light projected onto an area of an object that conveys information which may be used to determine coordinates of points on the object. In one embodiment, a structured light pattern will contain at least three non-collinear pattern elements disposed within the area. Each of the three non-collinear pattern elements conveys information which may be used to determine the point coordinates. In another embodiment, a projector is provided that is configurable to project both an area pattern as well as a line pattern. In one embodiment, the projector is a digital micromirror device (DMD), which is configured to switch back and forth between the two. In one embodiment, the DMD projector may also sweep a line or to sweep a point in a raster pattern.

In general, there are two types of structured light patterns, a coded light pattern and an uncoded light pattern. As used herein a coded light pattern is one in which the three dimensional coordinates of an illuminated surface of the object are found by acquiring a single image. With a coded light pattern, it is possible to obtain and register point cloud data while the projecting device is moving relative to the object. One type of coded light pattern contains a set of elements (e.g. geometric shapes) arranged in lines where at least three of the elements are non-collinear. Such pattern elements are recognizable because of their arrangement.

In contrast, an uncoded structured light pattern as used herein is a pattern that does not allow measurement through a single pattern. A series of uncoded light patterns may be projected and imaged sequentially. For this case, it is usually necessary to hold the projector fixed relative to the object.

It should be appreciated that the scanner 20 may use either coded or uncoded structured light patterns. The structured light pattern may include the patterns disclosed in the journal article “DLP-Based Structured Light 3D Imaging Technologies and Applications” by Jason Geng published in the Proceedings of SPIE, Vol. 7932, which is incorporated herein by reference. In addition, in some embodiments described herein below, the projector 28 transmits a pattern formed a swept line of light or a swept point of light. Swept lines and points of light provide advantages over areas of light in identifying some types of anomalies such as multipath interference. Sweeping the line automatically while the scanner is held stationary also has advantages in providing a more uniform sampling of surface points.

The first camera 24 includes a photosensitive sensor 44 which generates a digital image/representation of the area 48 within the sensor's field of view. The sensor may be charged-coupled device (CCD) type sensor or a complementary metal-oxide-semiconductor (CMOS) type sensor for example having an array of pixels. The first camera 24 may further include other components, such as but not limited to lens 46 and other optical devices for example. The lens 46 has an associated first focal length. The sensor 44 and lens 46 cooperate to define a first field of view “X”. In the exemplary embodiment, the first field of view “X” is 16 degrees (0.28 inch per inch).

Similarly, the second camera 26 includes a photosensitive sensor 38 which generates a digital image/representation of the area 40 within the sensor's field of view. The sensor may be charged-coupled device (CCD) type sensor or a complementary metal-oxide-semiconductor (CMOS) type sensor for example having an array of pixels. The second camera 26 may further include other components, such as but not limited to lens 42 and other optical devices for example. The lens 42 has an associated second focal length, the second focal length being different than the first focal length. The sensor 38 and lens 42 cooperate to define a second field of view “Y”. In the exemplary embodiment, the second field of view “Y” is 50 degrees (0.85 inch per inch). The second field of view Y is larger than the first field of view X. Similarly, the area 40 is larger than the area 48. It should be appreciated that a larger field of view allows acquired a given region of the object surface 32 to be measured faster; however, if the photosensitive arrays 44 and 38 have the same number of pixels, a smaller field of view will provide higher resolution.

In the exemplary embodiment, the projector 28 and the first camera 24 are arranged in a fixed relationship at an angle such that the sensor 44 may receive light reflected from the surface of the object 34. Similarly, the projector 28 and the second camera 26 are arranged in a fixed relationship at an angle such that the sensor 38 may receive light reflected from the surface 32 of object 34. Since the projector 28, first camera 24 and second camera 26 have fixed geometric relationships, the distance and the coordinates of points on the surface may be determined by their trigonometric relationships. Although the fields-of-view (FOVs) of the cameras 24 and 26 are shown not to overlap in FIG. 4, the FOVs may partially overlap or totally overlap.

The projector 28 and cameras 24, 26 are electrically coupled to a controller 50 disposed within the housing 22. The controller 50 may include one or more microprocessors, digital signal processors, memory and signal conditioning circuits. The scanner 20 may further include actuators (not shown) which may be manually activated by the operator to initiate operation and data capture by the scanner 20. In one embodiment, the image processing to determine the X, Y, Z coordinate data of the point cloud representing the surface 32 of object 34 is performed by the controller 50. The coordinate data may be stored locally such as in a volatile or nonvolatile memory 54 for example. The memory may be removable, such as a flash drive or a memory card for example. In other embodiments, the scanner 20 has a communications circuit 52 that allows the scanner 20 to transmit the coordinate data to a remote processing system 56. The communications medium 58 between the scanner 20 and the remote processing system 56 may be wired (e.g. Ethernet) or wireless (e.g. Bluetooth, IEEE 802.11). In one embodiment, the coordinate data is determined by the remote processing system 56 based on acquired images transmitted by the scanner 20 over the communications medium 58.

A relative motion is possible between the object surface 32 and the scanner 20, as indicated by the bidirectional arrow 47. There are several ways in which such relative motion may be provided. In an embodiment, the scanner is a handheld scanner and the object 34 is fixed. Relative motion is provided by moving the scanner over the object surface. In another embodiment, the scanner is attached to a robotic end effector. Relative motion is provided by the robot as it moves the scanner over the object surface. In another embodiment, either the scanner 20 or the object 34 is attached to a moving mechanical mechanism, for example, a gantry coordinate measurement machine or an articulated arm CMM. Relative motion is provided by the moving mechanical mechanism as it moves the scanner 20 over the object surface. In some embodiments, motion is provided by the action of an operator and in other embodiments, motion is provided by a mechanism that is under computer control.

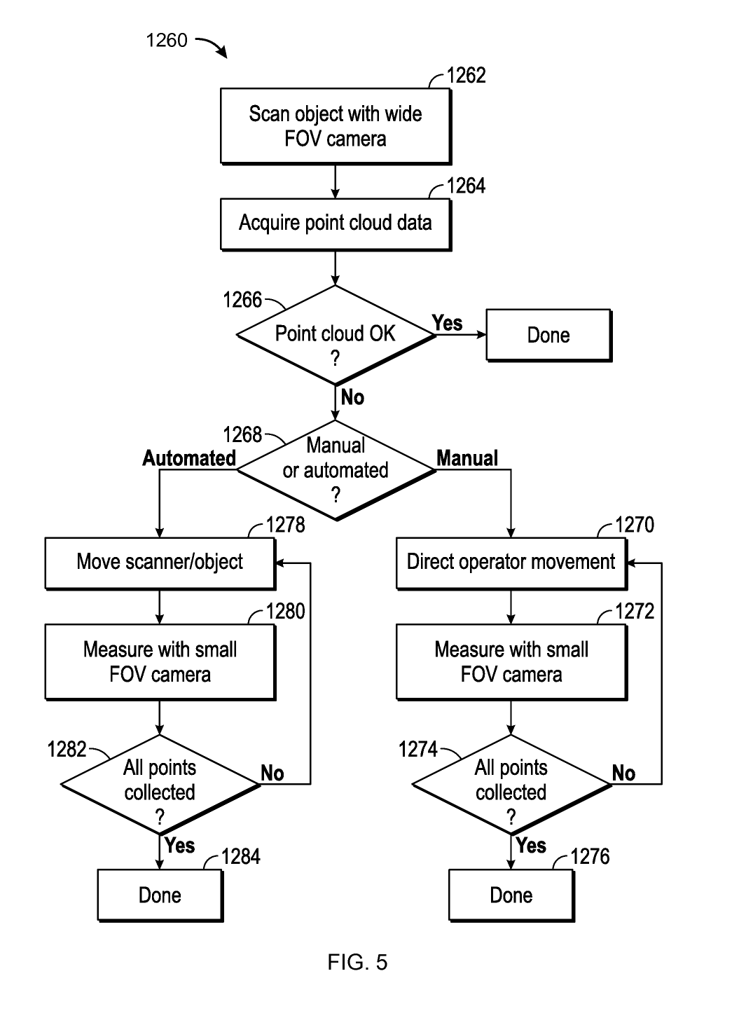

Referring now to FIG. 5, the operation of the scanner 20 according to a method 1260 is described. As shown in block 1262, the projector 28 first emits a structured light pattern onto the area 37 of surface 32 of the object 34. The light 30 from projector 28 is reflected from the surface 32 as reflected light 62 received by the second camera 26. The three-dimensional profile of the surface 32 affects the image of the pattern captured by the photosensitive array 38 within the second camera 26. Using information collected from one or more images of the pattern or patterns, the controller 50 or the remote processing system 56 determines a one to one correspondence between the pixels of the photosensitive array 38 and pattern of light emitted by the projector 28. Using this one-to-one correspondence, triangulation principals are used to determine the three-dimensional coordinates of points on the surface 32. This acquisition of three-dimensional coordinate data (point cloud data) is shown in block 1264. By moving the scanner 20 over the surface 32, a point cloud may be created of the entire object 34.

During the scanning process, the controller 50 or remote processing system 56 may detect an undesirable condition or problem in the point cloud data, as shown in block 1266. The detected problem may be an error in or absence of point cloud data in a particular area for example. This error in or absence of data may be caused by too little or too much light reflected from that area. Too little or too much reflected light may result from a difference in reflectance over the object surface, for example, as a result of high or variable angles of incidence of the light 30 on the object surface 32 or as a result of low reflectance (black or transparent) materials or shiny surfaces. Certain points on the object may be angled in such as way as to produce a very bright specular reflectance known as a glint.

Another possible reason for an error in or absence of point cloud data is a lack of resolution in regions having fine features, sharp edges, or rapid changes in depth. Such lack of resolution may be the result of a hole, for example.

Another possible reason for an error in or an absence of point cloud data is multipath interference. Ordinarily a ray of light from the projector 36 strikes a point on the surface 32 and is scattered over a range of angles. The scattered light is imaged by the lens 42 of camera 26 onto a small spot on the photosensitive array 38. Similarly, the scattered light may be imaged by the lens 46 of camera 24 onto a small spot on the photosensitive array 24. Multipath interference occurs when the light reaching the point on the surface 32 does not come only from the ray of light from the projector. In addition, secondary light is reflected off another portion of the surface 32. Such added light may compromise the pattern of light, thereby preventing accurate determination of three-dimensional coordinates of the point.

If the controller determines that the point cloud is all right in block 1266, the procedure is finished. Otherwise, a determination is made in block 1268 of whether the scanner is used in a manual or automated mode. If the mode is manual, the operator is directed in block 1270 to move the scanner into the desired position.

There are many ways that the movement desired by the operator may be indicated. In an embodiment, indicator lights on the scanner body indicate the desired direction of movement. In another embodiment, a light is projected onto the surface indicating the direction over which the operator is to move. In addition, a color of the projected light may indicate whether the scanner is too close or too far from the object. In another embodiment, an indication is made on display of the region to which the operator is to project the light. Such a display may be a graphical representation of point cloud data, a CAD model, or a combination of the two. The display may be presented on a computer monitor or on a display built into the scanning device.

In any of these embodiments, a method of determining the approximate position of the scanner is desired. In one case, the scanner may be attached to an articulated arm CMM that uses angular encoders in its joints to determine the position and orientation of the scanner attached to its end. In another case, the scanner includes inertial sensors placed within the device. Inertial sensors may include gyroscopes, accelerometers, and magnetometers, for example. Another method of determining the approximate position of the scanner is to illuminate photogrammetric dots placed on or around the object as marker points. In this way, the wide FOV camera in the scanner can determine the approximate position of the scanner in relation to the object.

In another embodiment, a CAD model on a computer screen indicates the regions where additional measurements are desired, and the operator moves the scanner according by matching the features on the object to the features on the scanner. By updating the CAD model on the screen as a scan is taken, the operator may be given rapid feedback whether the desired regions of the part have been measured.

After the operator has moved the scanner into position, a measurement is made in block 1272 with the small FOV camera 24. By viewing a relatively smaller region in block 1272, the resolution of the resulting three-dimensional coordinates is improved and better capability is provided to characterize features such as holes and edges.

Because the narrow FOV camera views a relatively smaller region than the wide FOV camera, the projector 28 may illuminate a relatively smaller region. This has advantages in eliminating multipath interference since there is relatively fewer illuminated points on the object that can reflect light back onto the object. Having a smaller illuminated region may also make it easier to control exposure to obtain the optimum amount of light for a given reflectance and angle of incidence of the object under test. In the block 1274, if all points have been collected, the procedure ends at block 1276; otherwise it continues.

In an embodiment where the mode from block 1268 is automated, then in block 1278 the automated mechanism moves the scanner into the desired position. In some embodiments, the automated mechanism will have sensors to provide information about the relative position of the scanner and object under test. For an embodiment in which the automated mechanism is a robot, angular transducers within the robot joints provide information about the position and orientation of the robot end effector used to hold the scanner. For an embodiment in which the object is moved by another type of automated mechanism, linear encoders or a variety of other sensors may provide information on the relative position of the object and the scanner.

After the automated mechanism has moved the scanner or object into position, then in block 1280 three-dimensional measurements are made with the small FOV camera. Such measurements are repeated by means of block 1282 until all measurements are completed and the procedure finishes at block 1284.

In one embodiment, the projector 28 changes the structured light pattern when the scanner switches from acquiring data with the second camera 26 to the first camera 24. In another embodiment, the same structured light pattern is used with both cameras 24, 26. In still another embodiment, the projector 28 emits a pattern formed by a swept line or point when the data is acquired by the first camera 24. After acquiring data with the first camera 24, the process continues scanning using the second camera 26. This process continues until the operator has either scanned the desired area of the part.

It should be appreciated that while the process of FIG. 5 is shown as a linear or sequential process, in other embodiments one or more of the steps shown may be executed in parallel. In the method shown in FIG. 5, the method involved measuring the entire object first and then carrying out further detailed measurements according to an assessment of the acquired point cloud data. An alternative using the scanner 20 is to begin by measuring detailed or critical regions using the camera 24 having the small FOV.

It should also be appreciated that it is common practice in existing scanning systems to provide a way of changing the camera lens or projector lens as a way of changing the FOV of the camera or of projector in the scanning system. However, such changes are time consuming and typically require an additional compensation step in which an artifact such as a dot plate is placed in front of the camera or projector to determine the aberration correction parameters for the camera or projector system. Hence a scanning system that provides two cameras having different FOVs, such as the cameras 24, 26 of FIG. 4, provides a significant advantage in measurement speed and in enablement of the scanner for a fully automated mode.

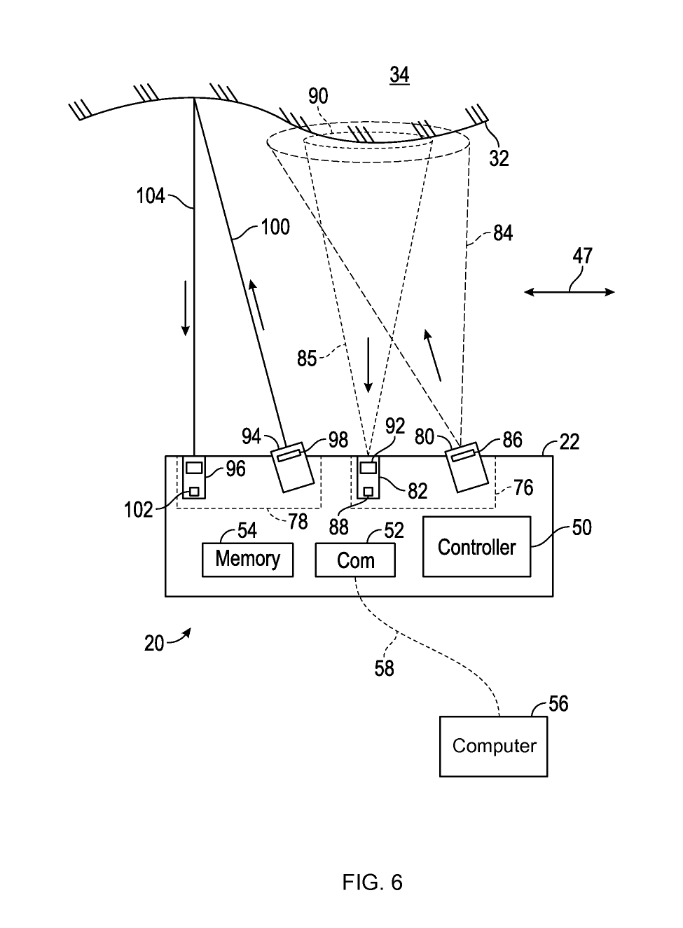

Another embodiment is shown in FIG. 6 of a scanner 20 having a housing 22 that includes a first coordinate acquisition system 76 and a second coordinate acquisition system 78. The first coordinate acquisition system 76 includes a first projector 80 and a first camera 82. Similar to the embodiment of FIG. 4, the projector 80 emits light 84 onto a surface 32 of an object 34. In the exemplary embodiment, the projector 80 uses a visible light source that illuminates a pattern generator. The visible light source may be a laser, a superluminescent diode, an incandescent light, a light emitting diode (LED), or other light emitting device. In one embodiment, the pattern generator is a chrome-on-glass slide having a structured light pattern etched thereon. The slide may have a single pattern or multiple patterns that move in and out of position as needed. The slide may be manually or automatically installed in the operating position. In other embodiments, the source pattern may be light reflected off or transmitted by a digital micro-mirror device (DMD) such as a digital light projector (DLP) manufactured by Texas Instruments Corporation, a liquid crystal device (LCD), a liquid crystal on silicon (LCOS) device, or a similar device used in transmission mode rather than reflection mode. The projector 80 may further include a lens system 86 that alters the outgoing light to have the desired focal characteristics.

The first camera 82 includes a photosensitive array sensor 88 which generates a digital image/representation of the area 90 within the sensor's field of view. The sensor may be charged-coupled device (CCD) type sensor or a complementary metal-oxide-semiconductor (CMOS) type sensor for example having an array of pixels. The first camera 82 may further include other components, such as but not limited to lens 92 and other optical devices for example. The first projector 80 and first camera 82 are arranged at an angle in a fixed relationship such that the first camera 82 may detect light 85 from the first projector 80 reflected off of the surface 32 of object 34. It should be appreciated that since the first camera 92 and first projector 80 are arranged in a fixed relationship, the trigonometric principals discussed above may be used to determine coordinates of points on the surface 32 within the area 90. Although for clarity FIG. 6 is depicted as having the first camera 82 near to the first projector 80, it should be appreciated that the camera could be placed nearer the other side of the housing 22. By spacing the first camera 82 and first projector 80 farther apart, accuracy of 3D measurement is expected to improve.

The second coordinate acquisition system 78 includes a second projector 94 and a second camera 96. The projector 94 has a light source that may comprise a laser, a light emitting diode (LED), a superluminescent diode (SLED), a Xenon bulb, or some other suitable type of light source. In an embodiment, a lens 98 is used to focus the light received from the laser light source into a line of light 100 and may comprise one or more cylindrical lenses, or lenses of a variety of other shapes. The lens is also referred to herein as a “lens system” because it may include one or more individual lenses or a collection of lenses. The line of light is substantially straight, i.e., the maximum deviation from a line will be less than about 1% of its length. One type of lens that may be utilized by an embodiment is a rod lens. Rod lenses are typically in the shape of a full cylinder made of glass or plastic polished on the circumference and ground on both ends. Such lenses convert collimated light passing through the diameter of the rod into a line. Another type of lens that may be used is a cylindrical lens. A cylindrical lens is a lens that has the shape of a partial cylinder. For example, one surface of a cylindrical lens may be flat, while the opposing surface is cylindrical in form.

In another embodiment, the projector 94 generates a two-dimensional pattern of light that covers an area of the surface 32. The resulting coordinate acquisition system 78 is then referred to as a structured light scanner.

The second camera 96 includes a sensor 102 such as a charge-coupled device (CCD) type sensor or a complementary metal-oxide-semiconductor (CMOS) type sensor for example. The second camera 96 may further include other components, such as but not limited to lens 104 and other optical devices for example. The second projector 94 and second camera 96 are arranged at an angle such that the second camera 96 may detect light 106 from the second projector 94 reflected off of the object 34. It should be appreciated that since the second projector 94 and the second camera 96 are arranged in a fixed relationship, the trigonometric principles discussed above may be used to determine coordinates of points on the surface 32 on the line formed by light 100. It should also be appreciated that the camera 96 and the projector 94 may be located on opposite sides of the housing 22 to increase 3D measurement accuracy.

In another embodiment, the second coordinate acquisition system is configured to project a variety of patterns, which may include not only a fixed line of light but also a swept line of light, a swept point of light, a coded pattern of light (covering an area), or a sequential pattern of light (covering an area). Each type of projection pattern has different advantages such as speed, accuracy, and immunity to multipath interference. By evaluating the performance requirements for each particular measurements and/or by reviewing the characteristics of the returned data or of the anticipated object shape (from CAD models or from a 3D reconstruction based on collected scan data), it is possible to select the type of projected pattern that optimizes performance.

In another embodiment, the distance from the second coordinate acquisition system 78 and the object surface 32 is different than the distance from the first coordinate acquisition system 76 and the object surface 32. For example, the camera 96 may be positioned closer to the object 32 than the camera 88. In this way, the resolution and accuracy of the second coordinate acquisition system 78 can be improved relative to that of the first coordinate acquisition system 76. In many cases, it is helpful to quickly scan a relatively large and smooth object with a lower resolution system 76 and then scan details including edges and holes with a higher resolution system 78.

A scanner 20 may be used in a manual mode or in an automated mode. In a manual mode, an operator is prompted to move the scanner nearer or farther from the object surface according to the acquisition system that is being used. Furthermore, the scanner 20 may project a beam or pattern of light indicating to the operator the direction in which the scanner is to be moved. Alternatively, indicator lights on the device may indicate the direction in which the scanner should be moved. In an automated mode, the scanner 20 or object 34 may be automatically moved relative to one another according to the measurement requirements.

Similar to the embodiment of FIG. 4, the first coordinate acquisition system 76 and the second coordinate acquisition system 78 are electrically coupled to a controller 50 disposed within the housing 22. The controller 50 may include one or more microprocessors, digital signal processors, memory and signal conditioning circuits. The scanner 20 may further include actuators (not shown) which may be manually activated by the operator to initiate operation and data capture by the scanner 20. In one embodiment, the image processing to determine the X, Y, Z coordinate data of the point cloud representing the surface 32 of object 34 is performed by the controller 50. The coordinate data may be stored locally such as in a volatile or nonvolatile memory 54 for example. The memory may be removable, such as a flash drive or a memory card for example. In other embodiments, the scanner 20 has a communications circuit 52 that allows the scanner 20 to transmit the coordinate data to a remote processing system 56. The communications medium 58 between the scanner 20 and the remote processing system 56 may be wired (e.g. Ethernet) or wireless (e.g. Bluetooth, IEEE 802.11). In one embodiment, the coordinate data is determined by the remote processing system 56 and the scanner 20 transmits acquired images on the communications medium 58.

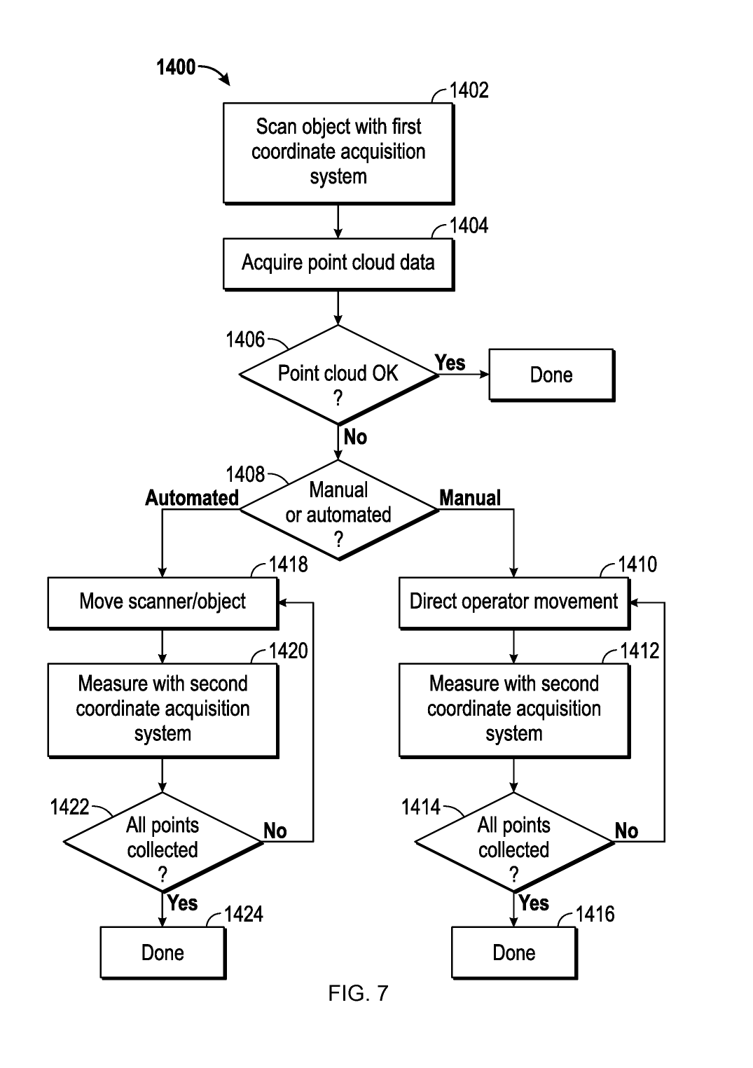

Referring now to FIG. 7, the method 1400 of operating the scanner 20 of FIG. 6 will be described. In block 1402, the first projector 80 of the first coordinate acquisition system 76 of scanner 20 emits a structured light pattern onto the area 90 of surface 32 of the object 34. The light 84 from projector 80 is reflected from the surface 32 and the reflected light 85 is received by the first camera 82. As discussed above, the variations in the surface profile of the surface 32 create distortions in the imaged pattern of light received by the first photosensitive array 88. Since the pattern is formed by structured light, a line or light, or a point of light, it is possible in some instances for the controller 50 or the remote processing system 56 to determine a one to one correspondence between points on the surface 32 and the pixels in the photosensitive array 88. This enables triangulation principles discussed above to be used in block 1404 to obtain point cloud data, which is to say to determine X, Y, Z coordinates of points on the surface 32. By moving the scanner 20 relative to the surface 32, a point cloud may be created of the entire object 34.

In block 1406, the controller 50 or remote processing system 56 determines whether the point cloud data possesses the desired data quality attributes or has a potential problem. The types of problems that may occur were discussed hereinabove in reference to FIG. 5 and this discussion is not repeated here. If the controller determines that the point cloud has the desired data quality attributes in block 1406, the procedure is finished. Otherwise, a determination is made in block 1408 of whether the scanner is used in a manual or automated mode. If the mode is manual, the operator is directed in block 1410 to move the scanner to the desired position.

There are several ways of indicating the desired movement by the operator as described hereinabove with reference to FIG. 5. This discussion is not repeated here.

To direct the operator in obtaining the desired movement, a method of determining the approximate position of the scanner is needed. As explained with reference to FIG. 5, methods may include attachment of the scanner 20 to an articulated arm CMM, use of inertial sensors within the scanner 20, illumination of photogrammetric dots, or matching of features to a displayed image.

After the operator has moved the scanner into position, a measurement is made with the second coordinate acquisition system 78 in block 1412. By using the second coordinate acquisition system, resolution and accuracy may be improved or problems may be eliminated. In block 1414, if all points have been collected, the procedure ends at block 1416; otherwise it continues.

If the mode of operation from block 1408 is automated, then in block 1420 the automated mechanism moves the scanner into the desired position. In most cases, an automated mechanism will have sensors to provide information about the relative position of the scanner and object under test. For the case in which the automated mechanism is a robot, angular transducers within the robot joints provide information about the position and orientation of the robot end effector used to hold the scanner. For other types of automated mechanisms, linear encoders or a variety of other sensors may provide information on the relative position of the object and the scanner.

After the automated mechanism has moved the scanner or object into position, then in block 1420 three-dimensional measurements are made with the second coordinate acquisition system 78. Such measurements are repeated by means of block 1422 until all measurements are completed. The procedure finishes at block 1424.

It should be appreciated that while the process of FIG. 7 is shown as a linear or sequential process, in other embodiments one or more of the steps shown may be executed in parallel. In the method shown in FIG. 7, the method involved measuring the entire object first and then carrying out further detailed measurements according to an assessment of the acquired point cloud data. An alternative using scanner 20 is to begin by measuring detailed or critical regions using the second coordinate acquisition system 78.

It should also be appreciated that it is common practice in existing scanning systems to provide a way of changing the camera lens or projector lens as a way of changing the FOV of the camera or of projector in the scanning system. However, such changes are time consuming and typically require an additional compensation step in which an artifact such as a dot plate is placed in front of the camera or projector to determine the aberration correction parameters for the camera or projector system. Hence a system that provides two different coordinate acquisition systems such as the scanning system 20 of FIG. 6 provides a significant advantage in measurement speed and in enablement of the scanner for a fully automated mode.

### Example Embodiments of the Invention

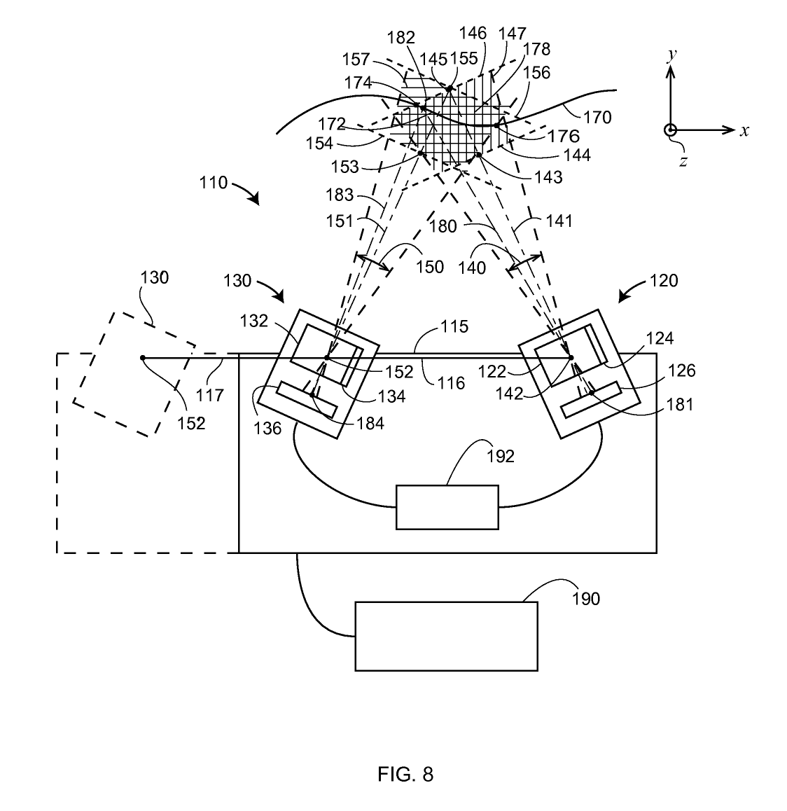

In an embodiment illustrated in FIG. 8, a triangulation scanner 110 includes a frame 115, a projector 120 and a camera 130, with the camera and projector attached to the frame. The projector 120 includes a projector zoom lens 122, a motorized zoom adjustment mechanism 124, and an illuminated pattern source 126. The projector 120 has a projector FOV 140, a projector optical axis 141, a projector perspective center 142, a projector near point 143, a projector near plane 144, a projector far point 145, a projector far plane 146, a projector depth of field equal to a distance between the points 143 and 145, a projector near distance equal to a distance between the points 142 and 143, a projector far distance equal to a distance between the points 142 and 145. It is understood that the FOV is an angular region that covers a solid angle; in other words, the angular extent of FOV 140 extends on, out of, and into the paper in FIG. 8. The projector near plane 144 is a plane that is perpendicular to the projector optical axis 141 and that passes through the projector near point 143. The projector far plane 146 is a plane that is perpendicular to the projector optical axis 141 and that passes through the projector far point. The projector near planes and far planes establish a range of distances from the camera over which projected patterns on the surface 170 are relatively clear, which is to say the range over which the images are relatively unblurred (in focus). It will be appreciated from all that is disclosed herein that surface 170 may have x, y and z components relative to an orthogonal coordinate system, where the positive z-axis extends out of the paper as viewed from the perspective of FIGS. 8-10. The dividing line between blurred and unblurred is defined in terms of requirements of a particular application, which in this case is in terms of the accuracy of 3D coordinates obtained with the scanner 110. The projector perspective center 142 is a point through which an ideal ray of light 180 passes after emerging from a corrected point 181 on its way to a point 182 on a surface 170. Because of aberrations in the lens 122, not all real rays of light emerge from the single perspective center point 142. However, in an embodiment, aberrations are removed by means of computational methods so that the point 181 is corrected in position to compensate for lens aberrations. Following such correction, each ideal ray 180 passes through the perspective center 142. Technical details regarding the concept of “perspective center” are given in publication '550 and discussed above. A method for obtaining compensation parameters for the correction of the point 181 are discussed further hereinbelow. A 3D region of space 147 (represented by vertical lines) within the projector FOV 140 and between the projector near plane 144 and the projector far plane 146 is considered to be a “projection in-focus” region. In this region, a pattern projected from the illuminated pattern source 126 onto a portion of the surface 170 is considered to be “in focus”, which is to say that the pattern on the object surface within the region of space 147 is considered to be relatively clear rather than blurred.

The projector zoom lens 120 has a projector zoom ratio, which is defined as a ratio of a maximum focal length of the projector zoom lens 122 to a minimum focal length of the projector zoom lens 122. The projector zoom ratio also represents the ratio of a maximum projector FOV to a minimum projector FOV. Ordinarily the zooming function of a zoom lens assembly is achieved by moving a lens element relative to two or more lens elements within the zoom lens. The zooming function may produce a relatively large change in focal length (and FOV) of the projector zoom lens 122. In addition, the projector zoom lens may include a focus adjustment mechanism that permits focusing of the light for surfaces at different distances. In other words, the focus adjustment permits projecting or receiving of relatively unblurred images for different distances between the projector zoom lens 122 and the surface 170. In some cases, the lens may provide an autofocus mechanism that automatically adjusts a lens element within the zoom lens assembly to obtain the focused state. As in the case of the zoom mechanism, the focusing mechanism adjusts the focal length of the lens assembly, but by a smaller amount than the zoom mechanism. The combination of the zoom adjustment mechanism and the focus adjustment mechanism of the projector zoom lens 122 determines the location of the projection in-focus region 147. The perspective center 142 may move relative to the illuminated pattern source 126 as a result of change in focal length of the projector zoom lens 122 by the zoom and focus adjustments.

The camera 130 includes a camera zoom lens 132, a motorized zoom adjustment mechanism 134, and a photosensitive array 136. The camera 130 has a camera FOV 150, a camera optical axis 151, a camera perspective center 152, a camera near point 153, a camera near plane 154, a camera far point 155, a camera far plane 156, a camera depth of field equal to a distance between the points 153 and 155, a camera near distance equal to a distance between the points 152 and 153, a camera far distance equal to a distance between the points 152 and 155. The camera near plane 154 is a plane perpendicular to the camera optical axis 151 that passes through the camera near point 153. The camera far plane 156 is a plane perpendicular to the camera optical axis 151 that passes through the camera far point 155. The camera perspective center 152 is a point through which an ideal ray of light 183 passes after emerging from the point of light 182 on the surface 170 on its way to the corrected point 184 on the photosensitive array 136. Because of aberrations in the camera zoom lens 132, a real ray that passes through the camera perspective center 152 does not necessarily strike the photosensitive array at the point 184. Rather in an embodiment the position of the point on the photosensitive array 136 is corrected computationally to obtain a corrected point 139. A method for obtaining compensation parameters to find the position of the corrected point 184 is discussed further hereinbelow. A 3D region of space 157 (represented by horizontal lines) within the camera FOV 150 and between the camera near plane 154 and the camera far plane 156 is considered to be a “camera in-focus” region. In this region, a pattern on the surface 170 is considered to be “in focus” on the photosensitive array 136, which is to say that the pattern on the photosensitive array 136 is considered to be relatively clear rather than blurred.

The zoom and focus adjustments for the camera zoom lens 132 are similar to the zoom and focus adjustments for the projector zoom lens 122 and so the discussion is not repeated here. The overlap region of the camera in-focus region 157 and the projector in-focus region 147 is a sweet-spot region 178 (represented by cross-hatched lines formed by the intersection of the aforementioned vertical and horizontal lines). A portion of a surface 170 between the points 174 and 176 is located in the sweet-spot region 178. The surface points in the sweet-spot region 178 are in focus when projected onto the surface 170 and are in focus when received by the photosensitive array 136. 3D coordinates of surface points located in the sweet spot are found by the scanner 110 with optimal accuracy.

A straight line segment that extends directly between the projector perspective center 142 and the camera perspective center 152 is the baseline 116, and a length of the baseline is a baseline length. Using rules of trigonometry, 3D coordinates of a point on the surface 170 may be calculated based at least in part on the baseline length, an orientation of the projector and the camera relative to the baseline, a position of a corresponding source point on the illuminated pattern source 126, and a position of a corresponding image point on the photosensitive array 136.

A processor 192 may be used to provide projector control, to obtain digital data from the photosensitive array 136, and to process the data to determine 3D coordinates of points on the surface 170. The processor 192 may also be used in computations related to compensation procedures, as described below, or to provide control for overall measurements according to a method. Optionally, a computer 190 may provide the functions described hereinabove for the processor 192. It may also be used to perform functions of application software, for example, in providing CAD models that may be fit to the collected 3D coordinate data. Either computer 190 or processor 192 may provide functions such as filtering or meshing of 3D point cloud data.

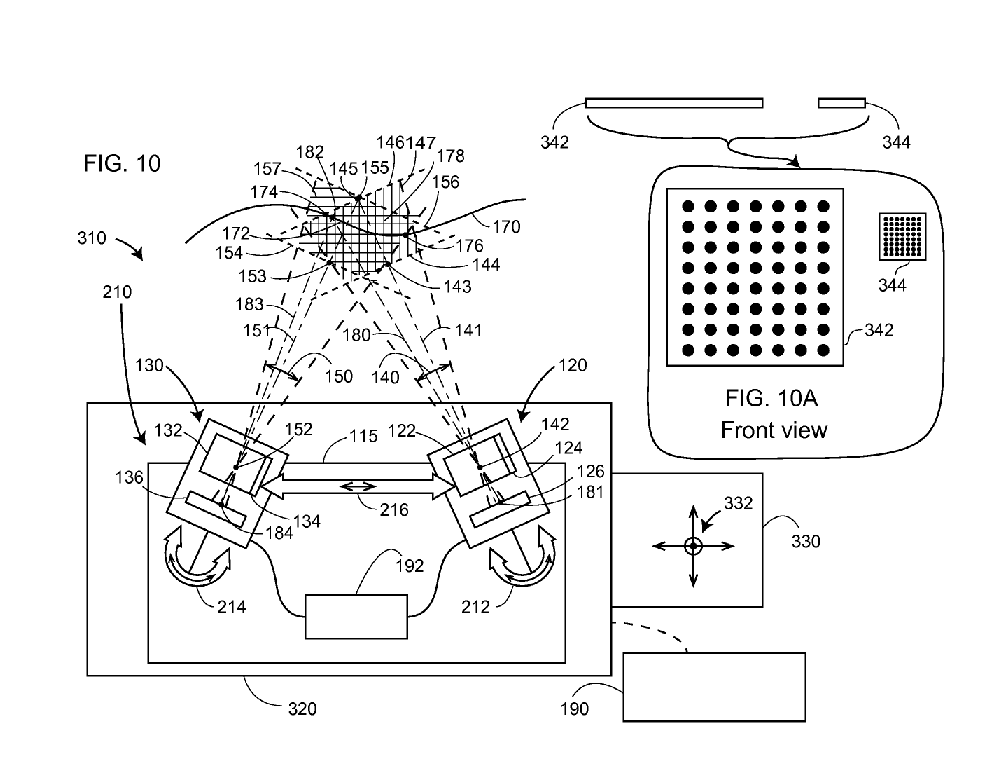

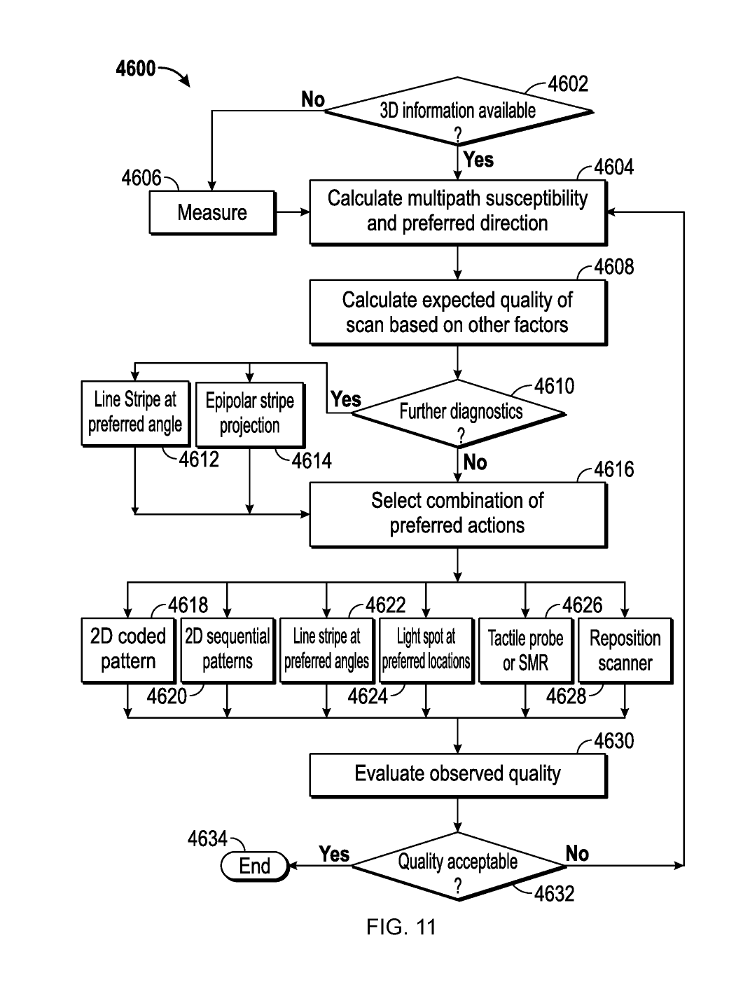

In an embodiment, a measurement is made with the camera 130 and the projector 120 set to a wide FOV to minimize the number of required measurements. An automated mechanism such as a robot 330 (best seen with reference to FIG. 10) may be used to move the scanner to place the sweet-spot region 178 over a portion of the surface 170. The position of the surface 170 relative to the scanner is set to a preferred distance, and the zoom and focus mechanisms of the projector 120 and the camera 130 are adjusted to a preferred condition. The preferred distance and the preferred condition are determined by the required measurement accuracy and the required speed of measurement. In an embodiment, a measurement is made with the camera and projector set to a narrow FOV. In an embodiment, the scanner 110 first measures 3D coordinates of a surface 170 by first measuring with the camera 130 and the projector 120 set to a wide FOV. The scanner 110 then measures 3D coordinates of a surface 170 by measuring with the camera 130 and the projector 120 set to a narrow FOV. In this way, an optimal tradeoff may be made between measurement speed and accuracy. This may be done without the need to manually change lenses. In an embodiment, an evaluation of the tradeoff between wide FOV and narrow FOV measurements is based at least in part on a quality factor obtained from a diagnostic procedure. In an embodiment, the quality factor is based at least in part on evaluation of 3D resolution or potential for multi-path interference. A method for obtaining a quality factor according to a diagnostic procedure is described in application '797, with exemplary paragraphs provided herein below with reference to FIG. 11.

With reference still to FIGS. 8-10, in an embodiment, only one of the camera and the projector includes a zoom lens.

In an embodiment, the scanner includes a second camera 130′ in addition to a first camera 130 and a projector 120. While not specifically illustrated, it will be appreciated that the second camera 130′ has all of the features and functionality of the first camera 130. In an embodiment, a camera-to-camera baseline distance 117, which is a distance between a perspective center 152 of the first camera 130 and a perspective center 152′ of the second camera 130′, is known. 3D coordinates of a surface are determined based at least on part on the camera-to-camera baseline distance. In this case, a baseline distance from the projector to the first camera and/or to the second camera may be known and used to improve accuracy in the calculation of 3D coordinates. Alternatively, the baseline distance from the projector to the first camera and/or to the second camera may not be known and the 3D coordinates determined using only the camera-to-camera baseline distance.

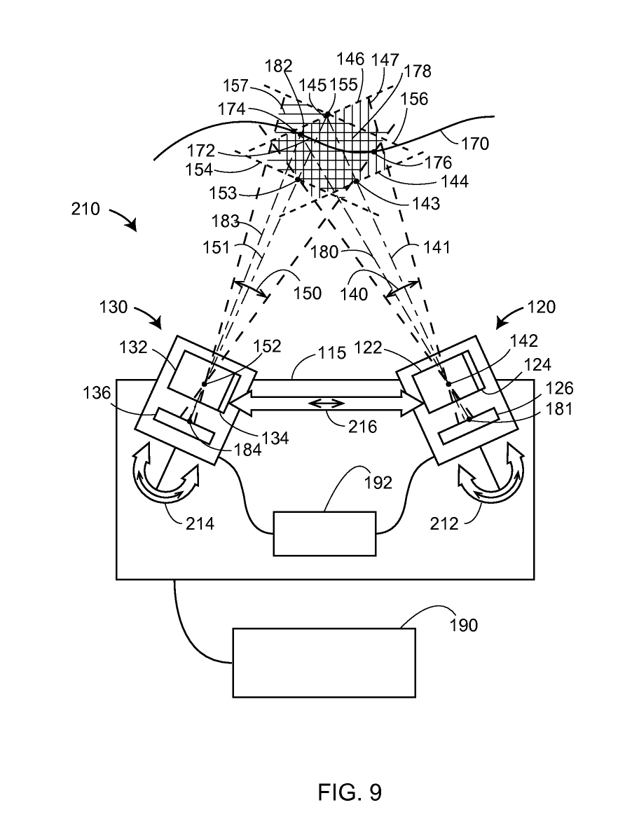

In an embodiment illustrated in FIG. 9, a triangulation scanner 210 includes the elements of FIG. 8 and in addition includes a motorized tilt mechanism 212 to vary an angle of rotation of the projector 120 relative to the baseline, a motorized tilt mechanism 214 to vary an angle of rotation of the camera 130 relative to the baseline, and a motorized separation mechanism to vary a separation distance between the projector 120 and the camera 130. By changing the angles of rotation of the projector 120 and camera 130, the motorized tilt mechanisms change the overlap of the projector FOV 140 and the camera FOV 150. The zoom and focus of the projector zoom lens 122 and the camera zoom lens 132 may be adjusted to align with the region of overlap of the projector FOV and the camera FOV. By this means, the sweet-spot region of the scanner may be altered. Such a method may be used to increase or decrease the size of the illuminated portion of the surface 170 in order to increase measurement speed or resolution. In other words, by this means, a single scanner may carry out highly resolved measurements of fine surface details or carry out faster but less resolved measurements over large volumes.

In an embodiment, the scanner 210 has only one or two of the group consisting of the motorized projector rotation mechanism 212, the motorized camera rotation mechanism 214, and the motorized separation mechanism 216.

In an embodiment illustrated in FIG. 10, a motorized movable triangulation scanner 310 includes a triangulation scanner 210, a scanner mount 320, a moveable stage 330, and calibration artifacts 342, 344. The triangulation scanner 210 is coupled to the scanner mount 320, which is attached to moveable stage 330. Some possible directions of motion (up, down, forward, backward, left, right) are represented by element 332. Other motions such as rotations are also possible. In an embodiment, the moveable stage 330 is a robot and the mount 320 is an attachment for a robot end effector. In another embodiment, the moveable stage 330 is a motorized gantry mechanism. Calibration artifacts 342, 344 include patterns that enable determination of scanner characteristics such as lens aberrations, baseline distance, and angles of tilt of the projector 120 and camera 130 relative to the baseline. In an embodiment, the artifacts are dot plates 342, 344. In an embodiment, each dot plate includes a collection of dots spaced at known positions. In other embodiments, each dot plate includes lines or checkerboards. In some embodiments, markers are provided to enable rapid identification of target elements. In an embodiment, calibration artifacts in multiple sizes are provided to enable good compensation of the scanner 210 when configured to measure either relatively large or relatively small surface areas before moving the mount 320 with the scanner 210 attached via the moveable stage 330.

In an embodiment, a compensation procedure includes steps of illuminating an artifact with a pattern of light from the projector while measuring the resulting images with a camera. The camera is moved to a plurality of distances and tilted to a plurality of angles in relation to the dot plate. The resulting images received by the camera are converted into digital signals and sent to a processor, which carries out an optimization procedure to determine scanner compensation parameters. These parameters may include aberration coefficients for the camera, aberration coefficients for the projector, and the translation and orientation (six degrees of freedom) of the camera coordinate system in relation to the projector coordinate system. Optimization procedures are well known in the art and may include best-fit procedures such as least-squares minimization.

From the foregoing description of structural elements and their functionality, it will be appreciated that an embodiment of a measurement method is also disclosed herein. In a first step, a scanner having at least a motorized projector zoom lens or a motorized camera zoom lens is provided and is mounted on a motorized moveable stage. In a second step, the scanner is moved to a desired position and set to a desired camera projector zoom, focus, tilt, and separation. In a third step, the scanner projects a first pattern of light onto a surface. In a fourth step, the scanner captures the first pattern of light on the surface with a camera and sends a digital representation of the image to a processor. In a fifth step, the processor makes triangulation calculations to find a first set of 3D coordinates of the surface. In a sixth step, at least one of the zoom and the focus is changed for at least one of the projector and the camera. In a seventh step, the scanner illuminates and views a calibration artifact. In an eighth step, the processor determines compensation parameters for the scanner. In a ninth step, the scanner projects a second pattern of light onto the surface. In a tenth step, the scanner captures a second image of the second pattern of light on the surface with a camera and sends a digital representation of a second image to the processor. In an eleventh step, the processor makes triangulation calculations to find a second set of 3D coordinates of the surface.

Method for Obtaining a Quality Factor According to a Diagnostic Procedure

A general approach may be used to evaluate not only multipath interference but also quality in general, including resolution and effect of material type, surface quality, and geometry. Referring now to FIG. 11, in an embodiment, a method 4600 may be carried out automatically under computer control. A step 4602 is to determine whether information on three-dimensional coordinates of an object under test are available. A first type of three-dimensional information is CAD data. CAD data usually indicates nominal dimensions of an object under test. A second type of three-dimensional information is measured three-dimensional data—for example, data previously measured with a scanner or other device. In some cases, the step 4602 may include a further step of aligning the frame of reference of the coordinate measurement device, for example, laser tracker or six-DOF scanner accessory, with the frame of reference of the object. In an embodiment, this is done by measuring at least three points on the surface of the object with the laser tracker.

If the answer to the question posed in step 4602 is that the three-dimensional information is available, then, in a step 4604, the computer or processor is used to calculate the susceptibility of the object measurement to multipath interference. In an embodiment, this is done by projecting each ray of light emitted by the scanner projector, and calculating the angle or reflection for each case. The computer or software identifies each region of the object surface that is susceptible to error as a result of multipath interference. The step 4604 may also carry out an analysis of the susceptibility to multipath error for a variety of positions of the six-DOF probe relative to the object under test. In some cases, multipath interference may be avoided or minimized by selecting a suitable position and orientation of the six-DOF probe relative to the object under test, as described hereinabove. If the answer to the question posed in step 4602 is that three-dimensional information is not available, then a step 4606 is to measure the three-dimensional coordinates of the object surface using any desired or preferred measurement method. Following the calculation of multipath interference, a step 4608 may be carried out to evaluate other aspects of expected scan quality. One such quality factor is whether the resolution of the scan is sufficient for the features of the object under test. For example, if the resolution of a device is 3 mm, and there are sub-millimeter features for which valid scan data is desired, then these problem regions of the object should be noted for later corrective action. Another quality factor related partly to resolution is the ability to measure edges of the object and edges of holes. Knowledge of scanner performance will enable a determination of whether the scanner resolution is good enough for given edges. Another quality factor is the amount of light expected to be returned from a given feature. Little if any light may be expected to be returned to the scanner from inside a small hole, for example, or from a glancing angle. Also, little light may be expected from certain kinds and colors of materials. Certain types of materials may have a large depth of penetration for the light from the scanner, and in this case good measurement results would not be expected. In some cases, an automatic program may ask for user supplementary information. For example, if a computer program is carrying out steps 4604 and 4608 based on CAD data, it may not know the type of material being used or the surface characteristics of the object under test. In these cases, the step 4608 may include a further step of obtaining material characteristics for the object under test.

Following the analysis of steps 4604 and 4608, the step 4610 is to decide whether further diagnostic procedures should be carried out. A first example of a possible diagnostic procedure is the step 4612 of projecting a stripe at a preferred angle to note whether multipath interference is observed. The general indications of multipath interference for a projected line stripe were discussed hereinabove with reference to FIG. 3B. Another example of a diagnostic step is step 4614, which is to project a collection of lines aligned in the direction of epipolar lines on the source pattern of light, for example, the source pattern of light 30 from projector 36 in FIG. 4. For the case in which lines of light in the source pattern of light are aligned to the epipolar lines, then these lines will also appear as straight lines in the image plane on the photosensitive array. The use of epipolar lines is discussed in more detail in commonly owned U.S. patent application Ser. No. 13/443,946 filed Apr. 11, 2012 the contents of which are incorporated by reference herein in its entirety. If these patterns on the photosensitive array are not straight lines or if the lines are blurred or noisy, then a problem is indicated, possibly as a result of multipath interference.

The step 4616 is to select a combination of preferred actions based on the analyses and diagnostic procedure performed. If speed in a measurement is particularly important, a step 4618 of measuring using a 2D (structured) pattern of coded light may be preferred. If greater accuracy is more important, then a step 4620 of measuring using a 2D (structured) pattern of coded light using sequential patterns, for example, a sequence of sinusoidal patterns of varying phase and pitch, may be preferred. If the method 4618 or 4620 is selected, then it may be desirable to also select a step 4628, which is to reposition the scanner, in other words to adjust the position and orientation of the scanner to the position that minimizes multipath interference and specular reflections (glints) as provided by the analysis of step 4604. Such indications may be provided to a user by illuminating problem regions with light from the scanner projector or by displaying such regions on a monitor display. Alternatively, the next steps in the measurement procedure may be automatically selected by a computer or processor. If the preferred scanner position does not eliminate multipath interference and glints, several options are available. In some cases, the measurement can be repeated with the scanner repositioned and the valid measurement results combined. In other cases, alternative measurement steps may be added to the procedure or performed instead of using structured light. As discussed previously, a step 4622 of scanning a stripe of light provides a convenient way of obtaining information over an area with reduced chance of having a problem from multipath interference. A step 4624 of sweeping a small spot of light over a region of interest further reduces the chance of problems from multipath interference. A step of measuring a region of an object surface with a tactile probe eliminates the possibility of multipath interference. A tactile probe provides a known resolution based on the size of the probe tip, and it eliminates issues with low reflectance of light or large optical penetration depth, which might be found in some objects under test.

In most cases, the quality of the data collected in a combination of the steps 4618-4628 may be evaluated in a step 4630 based on the data obtained from the measurements, combined with the results of the analyses carried out previously. If the quality is found to be acceptable in a step 4632, the measurement is completed at a step 4634. Otherwise, the analysis resumes at the step 4604. In some cases, the 3D information may not have been as accurate as desired. In this case, repeating some of the earlier steps may be helpful.

In all of the embodiments described hereinabove, the projected pattern may be a structured light pattern (area), a line pattern (which may be swept), or a dot pattern (which may be swept into a line or moved in a raster pattern to cover an area).

From the foregoing description of structural elements and their functionality, it will be appreciated that another embodiment of a measurement method is further disclosed herein, where a procedure is carried out to perform one or more overview measurements, carry out a diagnostic procedure, adjust camera settings using motorized elements, and calculate 3D coordinates of points on a surface.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A noncontact optical three-dimensional (3D) scanning and measuring device, comprising:
a projector having an illuminated pattern source, a projector field of view (FOV), a projector perspective center, a projector near plane, and projector far plane, wherein a 3D region of space when disposed within the projector FOV and between the projector near plane and the projector far plane defines a projection-in-focus region;
a camera having a photosensitive array, a camera FOV, a camera perspective center, a camera near plane, and a camera far plane, wherein a 3D region of space when disposed within the camera FOV and between the camera near plane and the camera far plane defines a camera-in-focus region; and
a processor in signal communication with the projector and the camera;
wherein the camera perspective center and the projector perspective center are disposed in relation to each other by a baseline having a baseline length;
wherein at least one of the projector and the camera comprises a zoom lens and a motorized zoom adjustment mechanism;
wherein the projector and the camera have a sweet-spot region that includes an overlap of the camera-in-focus region and the projector-in-focus region;
wherein 3D coordinates of points on a surface to be measured are measured when located within the sweet-spot region;
wherein the processor is responsive to executable instructions which when executed by the processor uses triangulation calculations to calculate the 3D coordinates of the points on the surface that are based at least in part on the baseline length, an orientation of the projector and the camera relative to the baseline, a position of a corresponding source point on the illuminated pattern source, and a position of a corresponding image point on the photosensitive array; and
wherein the 3D coordinates of the points on the surface are calculated at one time and at another time, at least one of the projector FOV being wider at the one time than at the another time or the camera FOV being wider at the one time than at the another time.

2. The device of claim 1, wherein each of the projector and the camera comprises a respective zoom lens and a motorized zoom adjustment mechanism, and wherein the 3D coordinates of the points on the surface are calculated at the one time and at the another time, the projector FOV being wider at the one time than at the another time and the camera FOV being wider at the one time than at the another time.

3. The device of claim 1, further comprising a robot disposed in operable communication with the projector and the scanner to move the projector and scanner to place the sweet-spot region over a portion of the surface to be measured.

4. The device of claim 1, further comprising at least one of: a first motorized tilt mechanism disposed in operable communication with the projector to vary an angle of rotation of the projector relative to the baseline; a second motorized tilt mechanism disposed in operable communication with the camera to vary an angle of rotation of the camera relative to the baseline; and, a motorized separation mechanism disposed in operable communication with the projector and the camera to vary a separation distance between the projector and the camera.

5. The device of claim 1, wherein the projector zoom lens comprises an autofocus mechanism configured to automatically adjust a lens element of the projector zoom lens to permit focusing of light from the illuminated pattern source on surface regions of the surface to be measured disposed at different distances from the projector zoom lens.

6. The device of claim 1, wherein the camera zoom lens comprises an autofocus mechanism configured to automatically adjust a lens element of the camera zoom lens to permit focusing on the photosensitive array an image of light from the illuminated pattern source on surface regions of the surface to be measured disposed at different distances from the camera zoom lens.

7. The device of claim 1, wherein the camera is a first camera, and the baseline length is a first baseline length, and further comprising:
a second camera having all of the features and functions of the first camera;
wherein the camera perspective center of the first camera and the camera perspective center of the second camera are disposed in relation to each other by a camera-to-camera baseline having a camera-to-camera baseline length;
wherein the camera perspective center of the second camera and the projector perspective center are disposed in relation to each other by a second baseline having a second baseline length;
wherein the processor is further responsive to executable instructions which when executed by the processor uses triangulation calculations to calculate the 3D coordinates of the points on the surface that are further based at least in part on the camera-to-camera baseline length.

8. The device of claim 7, wherein:
the processor is further responsive to executable instructions which when executed by the processor uses triangulation calculations to calculate the 3D coordinates of the points on the surface that are based at least in part on: the first baseline length; the second baseline length; or, both the first baseline length and the second baseline length.

9. The device of claim 7, wherein:
the processor is further responsive to executable instructions which when executed by the processor uses triangulation calculations to calculate the 3D coordinates of the points on the surface that are based at least in part on the camera-to-camera baseline length, and are not based at least in part on the first and second baseline lengths.

10. A measurement method using a noncontact optical three-dimensional (3D) scanning and measuring device, the method comprising:
providing the noncontact 3D scanning and measuring device having at least one of a motorized projector zoom lens and a motorized camera zoom lens and being mounted on a motorized moveable stage, the device having a projector and a camera;
moving the device to a desired position and setting the projector and the camera to a desired zoom, focus, tilt, and separation setting;
projecting via the projector a first pattern of light onto a surface to be measured;
capturing via the camera an image of the first pattern of light on the surface and sending a digital representation of the image to a processor;
performing via the processor first triangulation calculations to establish a first set of 3D coordinates of the surface;
changing at least one of the zoom and the focus for at least one of the projector and the camera;
illuminating via the projector and viewing via the camera a calibration artifact;
determining via the processor using an optimization procedure compensation parameters for the device and performing a compensation procedure to improve measurement accuracy of the device;
subsequent to the compensation procedure, projecting via the projector a second pattern of light onto the surface to be measured;
capturing via the camera a second image of the second pattern of light on the surface and sending a digital representation of the second image to the processor; and
performing via the processor second triangulation calculations to establish a second set of 3D coordinates of the surface.

11. The method of claim 10, further comprising:
subsequent to the performing via the processor triangulation calculations to establish a second set of 3D coordinates of the surface, narrowing at least one of the projector FOV and the camera FOV relative to the prior projector FOV and the prior camera FOV, respectively;
projecting via the projector a third pattern of light onto the surface to be measured;
capturing via the camera a third image of the third pattern of light on the surface and sending a digital representation of the third image to a processor; and
performing via the processor triangulation calculations to establish a third set of 3D coordinates of the surface having a higher measurement resolution relative to the calculated second set of 3D coordinates, wherein the higher measurement resolution corresponds to smaller distance between points on the surface.

12. The method of claim 10, wherein the first pattern of light, the second pattern of light, or both the first and the second patterns of light, is a structured light pattern configured to illuminate an area.

13. The method of claim 10, wherein the first pattern of light, the second pattern of light, or both the first and the second patterns of light, is a line light pattern configured to be swept to illuminate an area.

14. The method of claim 10, wherein the first pattern of light, the second pattern of light, or both the first and the second patterns of light, is a dot light pattern configured to be swept to illuminate an area.
